(19) United States
(12) Patent Application Publication
(10) Pub. No.: US 2025/0324484 A1
(43) Pub. Date: Oct. 16, 2025

(54) ENHANCED USER EQUIPMENT STATE TRANSITIONS AND DYNAMIC DISCONTINUOUS RECEPTION PROCEDURE

(71) Applicant: QUALCOMM Incorporated, San Diego, CA (US)

(72) Inventor: Linhai HE, San Diego, CA (US)

(21) Appl. No.: 19/173,309

(22) Filed: Apr. 8, 2025

Related U.S. Application Data
(60) Provisional application No. 63/632,987, filed on Apr. 11, 2024.
(60) Provisional application No. 63/633,034, filed on Apr. 11, 2024.

(51) Int. Cl. H04W 76/28

(52) U.S. Cl. CPC H04W 76/28

(57) ABSTRACT

Methods, systems, and devices for wireless communications are described. A user equipment (UE) may operate in a first state and to transmit, to a network entity, a request to transition from the first state to a second state based on data activity between the UE and the network entity. The UE may transition from the first state to the second state based on transmitting the request to the network entity. The UE may perform the state transition based on a configuration from the network entity. The network entity may configure the UE to autonomously transition states based on transmitting the request or may configure the UE to receive a response message from the network prior to transitioning states. The UE may request to transition to a particular state, which may be selected by the UE.

### CROSS REFERENCE

This Patent Application claims the benefit of U.S. Provisional Patent Application No. 63/633,034 by H E et al., entitled “ENHANCED USER EQUIPMENT STATE TRANSITIONS,” filed Apr. 11, 2024, assigned to the assignee hereof, and expressly incorporated herein. This Patent Application claims the benefit of U.S. Provisional Patent Application No. 63/632,987 by H E et al., entitled “DYNAMIC DISCONTINUOUS RECEPTION PROCEDURES,” filed Apr. 11, 2024, assigned to the assignee hereof, and expressly incorporated herein.

### FIELD OF TECHNOLOGY

The following relates to wireless communications, including enhanced user equipment (UE) state transitions and dynamic discontinuous reception procedure.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support enhanced user equipment (UE) state transitions. For example, the described techniques may enable a UE to operate in a first state and to transmit, to a network entity, a request to transition from the first state to a second state based on data activity between the UE and the network entity. Accordingly, the UE may transition from the first state to the second state based on transmitting the request to the network entity. In some examples, the UE may perform the state transition based on a configuration from the network. For example, the network may configure the UE to autonomously transition states based on transmitting the request or may configure the UE to receive a response message from the network prior to transitioning states. Additionally, the UE may make a determination to transmit a state transmission request based on a machine learning model and may further train the model based on feedback from the network entity.

A method for wireless communications by a UE is described. The method may include transmitting, to a network entity and while operating in a first state, a request to transition from the first state to a second state based on data activity between the UE and the network entity and transitioning from the first state to the second state based on transmitting the request.

A UE for wireless communications is described. The UE may include one or more memories storing processor executable code, and one or more processors coupled with the one or more memories. The one or more processors may individually or collectively be operable to execute the code to cause the UE to transmit, to a network entity and while operating in a first state, a request to transition from the first state to a second state based on data activity between the UE and the network entity and transition from the first state to the second state based on transmitting the request.

Another UE for wireless communications is described. The UE may include means for transmitting, to a network entity and while operating in a first state, a request to transition from the first state to a second state based on data activity between the UE and the network entity and means for transitioning from the first state to the second state based on transmitting the request.

A non-transitory computer-readable medium storing code for wireless communications is described. The code may include instructions executable by one or more processors to transmit, to a network entity and while operating in a first state, a request to transition from the first state to a second state based on data activity between the UE and the network entity and transition from the first state to the second state based on transmitting the request.

In some examples of the method, UEs, and non-transitory computer-readable medium described herein, the request to transition from the first state to the second state includes a requested value for an inactivity timer at the UE and the UE transitions from the first state to the second state based on an expiration of the inactivity timer.

Some examples of the method, UEs, and non-transitory computer-readable medium described herein may further include operations, features, means, or instructions for receiving, from the network entity, an indication of a set of inactivity timer values associated with a transition from the first state to the second state and where the request includes an indication of a first inactivity timer value of the set of inactivity timer values, the first inactivity timer value selected by the UE based on receiving the indication of the set of inactivity timer values.

Some examples of the method, UEs, and non-transitory computer-readable medium described herein may further include operations, features, means, or instructions for receiving a response message from the network entity based on receiving the indication and transmitting the request, where the response message indicates that the request may be accepted by the network entity, an indication of a second inactivity timer value of the set of inactivity timer values, different than the first inactivity timer value, that the UE may be to use for transitioning from the first state to the second state, or any combination thereof, and where transitioning from the first state to the second state may be further based on receiving the response message.

Some examples of the method, UEs, and non-transitory computer-readable medium described herein may further include operations, features, means, or instructions for transmitting, to the network entity and while operating in a third state, a second request to transition from the third state to a fourth state based on data activity between the UE and the network entity, receiving a response message from the network entity based on transmitting the second request, where the response message indicates that the second request may be rejected by the network entity, and refraining from transitioning from the third state to the fourth state based on receiving the response message.

Some examples of the method, UEs, and non-transitory computer-readable medium described herein may further include operations, features, means, or instructions for transmitting, via the request, an indication of a requested state for the second state and where the requested state may be associated with a sleep state, an awake state, a state associated with a target bandwidth part, a radio resource control (RRC) state, a state associated with a deactivation of a secondary cell, or any combination thereof.

Some examples of the method, UEs, and non-transitory computer-readable medium described herein may further include operations, features, means, or instructions for receiving a control message from the network entity that configures whether the UE may be to transition from the first state to the second state based on an expiration of a timer or to refrain from transitioning from the first state to the second state based on the expiration of the timer, where the timer may be associated with receiving a response message from the network entity, and starting the timer based on transmitting the request.

Some examples of the method, UEs, and non-transitory computer-readable medium described herein may further include operations, features, means, or instructions for transitioning, in accordance with the control message, from the first state to the second state based on failing to receive the response message from the network entity prior to the expiration of the timer.

Some examples of the method, UEs, and non-transitory computer-readable medium described herein may further include operations, features, means, or instructions for receiving the response message from the network entity prior to the expiration of the timer and transitioning, in accordance with the control message, from the first state to the second state based on receiving the response message.

Some examples of the method, UEs, and non-transitory computer-readable medium described herein may further include operations, features, means, or instructions for receiving the response message from the network entity prior to the expiration of the timer, where the response message includes an indicated state that the UE may be to use for the second state, and transitioning from the first state to the second state in accordance with the indicated state based on receiving the response message.

Some examples of the method, UEs, and non-transitory computer-readable medium described herein may further include operations, features, means, or instructions for transmitting, to the network entity and while operating in a third state, a second request to transition from the third state to a fourth state based on data activity between the UE and the network entity, receiving, via the response message, an indication that the network entity rejected the second request from the UE, and refraining from transitioning from the third state to the fourth state based on receiving the response message.

Some examples of the method, UEs, and non-transitory computer-readable medium described herein may further include operations, features, means, or instructions for determining a predicted data activity between the UE and the network entity based on a machine learning model at the UE, where transmitting the request may be based on the predicted data activity satisfying a threshold, receiving, based on transmitting the request, a feedback message from the network entity that may be associated with the request, and training the machine learning model based on the feedback message received from the network entity.

Some examples of the method, UEs, and non-transitory computer-readable medium described herein may further include operations, features, means, or instructions for receiving a control message that configures a timer associated with transmitting the request, starting the timer based on transmitting the request, and refraining from transmitting a second request to transition from a third state to a fourth state prior to an expiration of the timer.

The described techniques further relate to improved methods, systems, devices, and apparatuses that support dynamic discontinuous reception (DRX) procedures. For example, the described techniques may enable a user equipment (UE) to operate in an active duration of a DRX cycle and to transmit, to a network entity, a request to transition to an inactive period of the DRX cycle based on data activity between the UE and a network entity. Accordingly, the UE may transition to the inactive period of the DRX cycle based on transmitting the request to the network entity. In some examples, the UE may perform the transition based on a configuration from the network. For example, the network entity may configure the UE to autonomously transition to the inactive period based on transmitting the request or may configure the UE to receive a response message from the network prior to transitioning to the inactive period. Additionally, the UE may make a determination to transmit a request based on a machine learning model and may further train the model based on feedback from the network entity.

A method for wireless communications by a UE is described. The method may include transmitting, within an active period of a DRX cycle, a request to transition to an inactive period of the DRX cycle based on data activity between the UE and a network entity and transitioning to the inactive period of the DRX cycle based on transmitting the request.

A UE for wireless communications is described. The UE may include one or more memories storing processor executable code, and one or more processors coupled with the one or more memories. The one or more processors may individually or collectively be operable to execute the code to cause the UE to transmit, within an active period of a DRX cycle, a request to transition to an inactive period of the DRX cycle based on data activity between the UE and a network entity and transition to the inactive period of the DRX cycle based on transmitting the request.

Another UE for wireless communications is described. The UE may include means for transmitting, within an active period of a DRX cycle, a request to transition to an inactive period of the DRX cycle based on data activity between the UE and a network entity and means for transitioning to the inactive period of the DRX cycle based on transmitting the request.

A non-transitory computer-readable medium storing code for wireless communications is described. The code may include instructions executable by one or more processors to transmit, within an active period of a DRX cycle, a request to transition to an inactive period of the DRX cycle based on data activity between the UE and a network entity and transition to the inactive period of the DRX cycle based on transmitting the request.

Some examples of the method, UEs, and non-transitory computer-readable medium described herein may further include operations, features, means, or instructions for receiving, from the network entity, an indication of a set of DRX inactivity timer values associated with transitioning to the inactive period of the DRX cycle and where the request includes an indication of a first DRX inactivity timer value of the set of DRX inactivity timer values, the first DRX inactivity timer value selected by the UE based on receiving the indication of the set of DRX inactivity timer values.

Some examples of the method, UEs, and non-transitory computer-readable medium described herein may further include operations, features, means, or instructions for receiving a response message from the network entity based on receiving the indication and transmitting the request, where the response message indicates that the request may be accepted by the network entity, an indication of a second DRX inactivity timer value of the set of DRX inactivity timer values, different from the first DRX inactivity timer value, that the UE may be to use for transitioning to the inactive period of the DRX cycle, or both, and where transitioning to the inactive period of the DRX cycle may be further based on receiving the response message.

Some examples of the method, UEs, and non-transitory computer-readable medium described herein may further include operations, features, means, or instructions for transmitting, within a second active period of a second DRX cycle, a second request to transition to a second inactive period of the second DRX cycle based on data activity between the UE and the network entity, receiving a second response message from the network entity based on transmitting the second request, where the second response message indicates that the second request may be rejected by the network entity, and refraining from transitioning to the second inactive period of the second DRX cycle based on receiving the second response message.

Some examples of the method, UEs, and non-transitory computer-readable medium described herein may further include operations, features, means, or instructions for transmitting, via the request, an indication of a duration associated with the inactive period of the DRX cycle.

Some examples of the method, UEs, and non-transitory computer-readable medium described herein may further include operations, features, means, or instructions for receiving a control message from the network entity that configures whether the UE may be to transition to the inactive period of the DRX cycle based on an expiration of a timer or to refrain from transitioning to the inactive period of the DRX cycle based on the expiration of the timer, where the timer may be associated with receiving a response message from the network entity, and starting the timer based on transmitting the request.

Some examples of the method, UEs, and non-transitory computer-readable medium described herein may further include operations, features, means, or instructions for transitioning, in accordance with the control message, to the inactive period of the DRX cycle based on failing to receive the response message from the network entity prior to the expiration of the timer.

Some examples of the method, UEs, and non-transitory computer-readable medium described herein may further include operations, features, means, or instructions for receiving the response message from the network entity prior to the expiration of the timer, where the response message includes an indicated duration that the UE may be to use for the inactive period of the DRX cycle, and transitioning, in accordance with the control message, to the inactive period of the DRX cycle based on receiving the response message.

Some examples of the method, UEs, and non-transitory computer-readable medium described herein may further include operations, features, means, or instructions for transmitting, within a second active period of a second DRX cycle, a second request to transition to a second inactive period of the second DRX cycle based on data activity between the UE and the network entity, receiving, via a second response message, an indication that the network entity rejected the second request from the UE, and refraining from transitioning to the second inactive period of the second DRX cycle based on receiving the second response message.

Some examples of the method, UEs, and non-transitory computer-readable medium described herein may further include operations, features, means, or instructions for receiving, from the network entity, an indication of a set of DRX cycle configurations and where the request includes a first DRX cycle configuration of the set of DRX cycle configurations, the first DRX cycle configuration selected by the UE based on receiving the indication of the set of DRX cycle configurations.

Some examples of the method, UEs, and non-transitory computer-readable medium described herein may further include operations, features, means, or instructions for receiving, from the network entity, an indication of a DRX cycle configuration including a set of active periods and a set of inactive periods and where the request includes a parameter that identifies a subset of active periods of the set of active periods within which the UE may be active.

Some examples of the method, UEs, and non-transitory computer-readable medium described herein may further include operations, features, means, or instructions for determining, based on a presence of an active timer value in a configuration of the DRX cycle, to transition to the inactive period of the DRX cycle in accordance with the active timer value.

Some examples of the method, UEs, and non-transitory computer-readable medium described herein may further include operations, features, means, or instructions for determining, based on an absence of an active timer value in a configuration of the DRX cycle, to refrain from transitioning to a second inactive period of the DRX cycle until transmitting a second request to transition to the second inactive period or until receiving a command from the network entity.

Some examples of the method, UEs, and non-transitory computer-readable medium described herein may further include operations, features, means, or instructions for receiving a response message based on transmitting the request prior to transitioning to the inactive period and where the response message indicates whether the UE may be to transition to the inactive period of the DRX cycle in accordance with an active timer value, or may be to refrain from transitioning to the inactive period of the DRX cycle until transmitting the request.

Some examples of the method, UEs, and non-transitory computer-readable medium described herein may further include operations, features, means, or instructions for determining a predicted data activity between the UE and the network entity based on a machine learning model at the UE, where transmitting the request may be based on the predicted data activity satisfying a threshold, receiving, based on transmitting the request, a feedback message from the network entity that may be associated with the request, and training the machine learning model based on the feedback message received from the network entity.

Some examples of the method, UEs, and non-transitory computer-readable medium described herein may further include operations, features, means, or instructions for receiving a control message that configures a timer associated with transmitting the request, starting the timer based on transmitting the request, and refraining from transmitting a second request to transition to a second inactive period of the DRX cycle prior to an expiration of the timer based on receiving the control message.

Some examples of the method, UEs, and non-transitory computer-readable medium described herein may further include operations, features, means, or instructions for receiving a control message that configures a default duration for the UE to use for the inactive period of the DRX cycle and where the UE uses the default duration for the inactive period based on an absence of a duration from the request.

In some examples of the method, UEs, and non-transitory computer-readable medium described herein, for the inactive period and for at least a second inactive period of the DRX cycle, the UE uses a first duration that may be indicated via the request, or via a response message from the network entity, based on an absence of a second duration from a second request to transition to the second inactive period.

### BRIEF DESCRIPTION OF THE DRAWINGS

FIG. 1 shows an example of a wireless communications system that supports enhanced user equipment (UE) state transitions and dynamic discontinuous reception (DRX) procedures in accordance with one or more aspects of the present disclosure.

FIG. 2 shows an example of a wireless communication system that supports enhanced UE and dynamic DRX procedures state transitions in accordance with one or more aspects of the present disclosure.

FIG. 3 shows an example of a process flow that supports enhanced UE state transitions in accordance with one or more aspects of the present disclosure.

FIG. 4 shows an example of a DRX cycle that supports dynamic DRX procedures in accordance with one or more aspects of the present disclosure.

FIG. 5 shows an example of a process flow that supports dynamic DRX procedures in accordance with one or more aspects of the present disclosure.

FIG. 6 shows a block diagram of a device that support enhanced UE state transitions in accordance with one or more aspects of the present disclosure.

FIG. 7 shows a block diagram of a communications manager that supports enhanced UE state transitions in accordance with one or more aspects of the present disclosure.

FIG. 8 shows a block diagram of a device that supports dynamic DRX procedures in accordance with one or more aspects of the present disclosure.

FIG. 9 shows a block diagram of a communications manager that supports dynamic DRX procedures in accordance with one or more aspects of the present disclosure.

FIG. 10 shows a diagram of a system including a device that supports enhanced UE state transitions and dynamic DRX procedures in accordance with one or more aspects of the present disclosure.

FIGS. 11 through 13 show flowcharts illustrating methods that support enhanced UE state transitions in accordance with one or more aspects of the present disclosure.

FIGS. 14 through 16 show flowcharts illustrating methods that support dynamic DRX procedures in accordance with one or more aspects of the present disclosure.

### DETAILED DESCRIPTION

In some wireless communications systems, a user equipment (UE) may operate in accordance with various states. For instance, a UE may operate in accordance with various discontinuous communication states (e.g., an active state of discontinuous reception (DRX), an inactive state of DRX), bandwidth configuration states (e.g., bandwidth part (BWP) states), data inactivity states (e.g., radio resource control (RRC) states, RRC inactive, RRC idle), and secondary cell (SCell) states (e.g., SCell activated, SCell deactivated), among other examples. In some cases, the UE may be configured to utilize various inactivity timers (e.g., DRX inactivity timer, BWP inactivity timer, data inactivity timer, SCell deactivation timer) to trigger a transition from one state to another state. The inactivity timers may be activated (e.g., initiated) in response to an event such as identifying that data is not actively being communicated between the UE and a network entity. In some cases, if the UE fails to identify any data for communication within a duration of an inactivity timer (e.g., prior to an expiration of the timer), the UE may transition from a first state to a second state (e.g., from an active state to a sleep state, from a first active BWP to a second active BWP). However, such inactivity timers may be statically or semi-statically configured by higher layer signaling (e.g., RRC signaling), and may be relatively difficult to reconfigure (e.g., based on increased signaling overhead). Further, a single inactivity timer may be applied for a broad range of applications (e.g., associated with various traffic conditions, associated with different patterns of power status changes) and may be relatively inefficient for at least some applications.

In accordance with one or more aspects described herein, a UE may be configured to support dynamic state transitions based on data activity. For example, a UE may operate in a first state and may transmit a message to the network entity that requests a transition from the first state to a second state based on data activity (e.g., a level of data inactivity) between the UE and the network entity. The UE may transition from the first state to the second state based on transmitting the request. By transmitting the request and transitioning states based on transmitting the request, the UE may be enabled to perform dynamic state transitions, which may support more efficient resource utilization. For example, the UE may adjust a duration for a given state in real-time, which may support reduced power consumption, increased battery life, improved data rates, and other benefits.

Additionally, in some examples, the network entity may configure a set of inactivity timer values, and the UE may indicate a requested value for a subsequent inactivity timer cycle. Additionally, or alternatively, the UE may transmit a direct indication of a requested value or a requested next state. In some examples, the network entity may transmit a control message that indicates a dynamic state transition configuration at the UE. The network entity may further transmit a response to the UE to accept, partially accept (e.g., accept a request to transition but reject a requested value for a timer duration), or reject the UE request. Additionally, in some examples, the UE may be configured with a machine learning model (e.g., an artificial intelligence (AI) algorithm, a neural network) that supports a determination of when to transmit the request. By transmitting a request with a selected value, the UE may further reduce power consumption based on dynamically adjusting (e.g., optimizing) its inactivity timers to adapt to various operating conditions. Further, by using a machine learning model, the UE may be enabled to predict occasions when inactivity timers may be adjusted to save power, improve data rates, or achieve other benefits, which may further improve efficiency in a wireless communications system.

In accordance with one or more aspects described herein, a wireless communications system may utilize signaling mechanisms to support dynamic configuration of DRX cycles based on data activity between a UE and a network entity. For example, the UE may, while operating within an active period of a DRX cycle, transmit a request message (e.g., a go-to-sleep request, a go-to-sleep indication) to the network entity that requests to transition to an inactive period of the DRX cycle based on data activity (e.g., a level of data inactivity) between the UE and the network entity. Accordingly, the UE may transition to the inactive period of the DRX cycle based on transmitting the request. By transmitting the request and transitioning to the inactive period of the DRX cycle, the UE may be enabled to switch to an inactive period on-demand (e.g., prior to an expiration of a preconfigured timer), which may support more-efficient resource utilization. For example, the UE may enter inactive periods for relatively longer durations, supporting reduced power consumption, increased battery life, reduced network traffic, and other benefits.

Additionally, in some examples, the network entity may configure (e.g., preconfigure) a set of DRX inactivity timer values, and the UE may indicate, via a request, a DRX inactivity timer value (e.g., a value for a DRX inactivity timer) from the set that is requested for a subsequent inactive period. Additionally, or alternatively, the UE may transmit, via the request, a direct indication of a requested duration for a subsequent inactive period (e.g., a requested sleep duration). In some examples, the network may transmit one or more control messages that configure the dynamic DRX cycle transition, such as the UE behavior based on transmitting the request. The network entity may further transmit a response to the UE to accept, partially accept (e.g., accept a request to go-to-sleep but reject a requested sleep duration), or reject the UE request. Additionally, in some examples, the UE may be configured with a machine learning model (e.g., an artificial intelligence (AI) algorithm, a neural network) that supports a determination (e.g., a prediction) of when the UE should enter an inactive duration and how long it should remain in the inactive duration.

Aspects of the disclosure are initially described in the context of wireless communications systems. Aspects of the disclosure are further illustrated by and described with reference to DRX cycles, process flows, apparatus diagrams, system diagrams, and flowcharts that relate to enhanced UE state transitions.

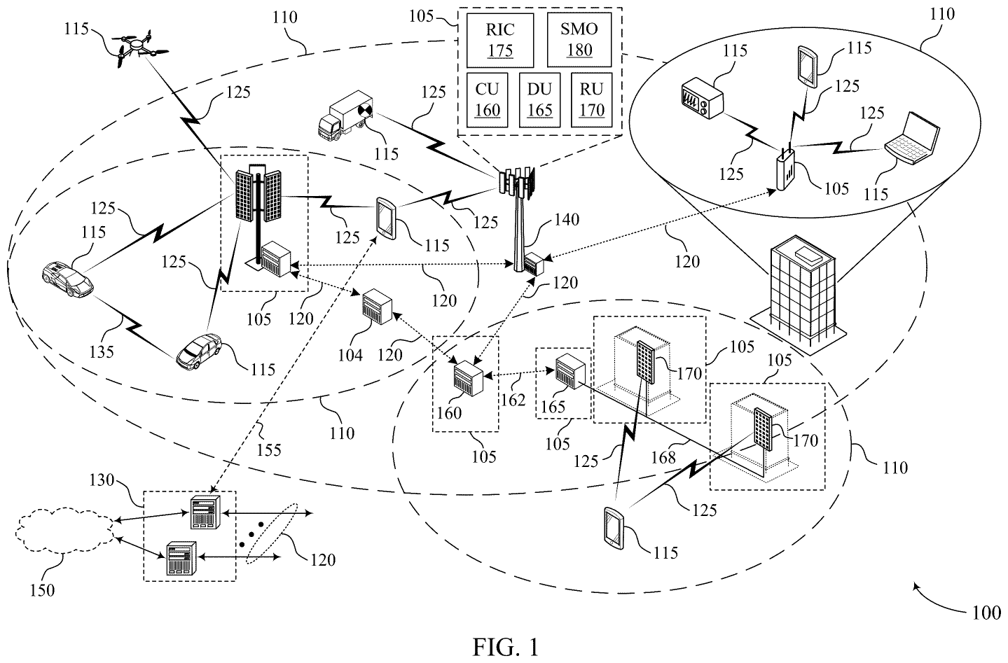

FIG. 1 shows an example of a wireless communications system 100 that supports enhanced UE state transitions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a BWP) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, a UE 115 may operate in accordance with various DRX states, BWP states, RRC inactivity states, and SCell states, among other examples. A UE 115 may be configured to utilize various inactivity timers to transition from one state to another state. However, reconfiguring such inactivity timers may be associated with relatively high signaling overhead, which may increase latency and degrade user experience in the wireless communications system 100. Further, a single inactivity timer may be applied for a broad range of applications (e.g., associated with various traffic conditions, associated with different patterns of power status changes), which may be relatively inefficient for some applications.

In accordance with one or more aspects described herein, a UE 115 may be configured to support dynamic state transitions based on data activity. In some examples, “data activity” may refer to a measure of data communication between the UE 115 and the network entity 105. For example, data activity may refer to a measure of a rate of data transfer (e.g., data rate), a volume of transferred data (e.g., data usage), or a quantity of resource allocations for data communication (e.g., data scheduling). For example, a UE 115 may operate in a first state and may transmit a request message to the network entity 105 that requests a transition from the first state to a second state based on data activity (e.g., a level of data activity, a data rate metric, a data usage metric, or a data scheduling metric not satisfying a threshold) between the UE 115 and the network entity 105. The UE 115 may transition from the first state to the second state based on transmitting the request. In some examples, the network entity 105 may configure a set of inactivity timer values and the UE 115 may indicate a requested value for a subsequent inactivity timer cycle. Additionally, or alternatively, the UE 115 may transmit a direct indication of a requested value or a requested next state. In some examples, the network entity 105 may transmit a control message to configure one or more dynamic state transition parameters at the UE 115. The network entity 105 may further transmit a response to the UE 115 to accept, partially accept (e.g., accept a request to transition but reject a requested value for a timer duration), or reject the UE 115 request. Additionally, in some examples, the UE 115 may be configured with a machine learning model (e.g., an artificial intelligence algorithm, a neural network) that supports a determination of when to transmit the request, and the UE may receive feedback from the network entity 105 to train the machine learning model. Accordingly, the devices (e.g., the UEs 115) within the wireless communications system 100 may operate with increased efficiency by dynamically adapting state transition configurations (e.g., via lower level signaling and machine learning models). For example, the UEs 115 may be enabled to increase power savings, improve data rates, decrease latency, and achieve other benefits for the wireless communications system 100.

In some cases, a UE 115 may operate in accordance with a DRX configuration, including a DRX cycle of active periods (e.g., DRX active periods) and inactive periods (e.g., DRX inactive periods). However, parameters associated with DRX configurations may be configured via higher layer signaling such as RRC signaling, which may be relatively difficult to reconfigure. Further, a single DRX configuration may be applied for a broad range of applications (e.g., associated with various traffic conditions, associated with different patterns of power status changes), which may be relatively inefficient for at least some applications (e.g., may increase power consumption in the wireless communications system 100).

In accordance with one or more aspects described herein, a wireless communications system 100 may utilize signaling mechanisms to support dynamic configuration of DRX cycles based on data activity (e.g., level of data activity not satisfying a threshold) between a UE 115 and a network entity 105. In some examples, “data activity” may refer to a measure of data communication between the UE 115 and the network entity 105. For example, data activity may refer to a measure of a rate of data transfer (e.g., data rate), a volume of transferred data (e.g., data usage), or a quantity of resource allocations for data communication (e.g., data scheduling). For example, the UE 115 may, while operating within an active period of a DRX cycle, transmit a request message (e.g., a go-to-sleep request, a go-to-sleep indication) to the network entity 105 that requests to transition to an inactive period of the DRX cycle, which may be based on data activity (e.g., a data rate metric, a data usage metric, a data scheduling metric) between the UE 115 and the network entity 105 failing to satisfy a threshold. Accordingly, the UE 115 may transition to the inactive period of the DRX cycle based on transmitting the request. Additionally, in some examples, the network entity 105 may configure (e.g., preconfigure) a set of DRX inactivity timer values, and the UE 115 may indicate, via a request, a DRX inactivity timer value (e.g., a value for a DRX inactivity timer) from the set (e.g., or not from the set) that is requested for a subsequent inactive period.

In some examples, the network may transmit one or more control messages, to the UE, that configure the dynamic DRX cycle transition. The network entity 105 may further transmit a response to the UE 115 to accept, partially accept (e.g., accept a request to go-to-sleep but reject a requested sleep duration), or reject the UE 115 request. Additionally, in some examples, the UE 115 may be configured with a machine learning model (e.g., an AI algorithm, a neural network) that supports a determination (e.g., a prediction) of when the UE 115 should enter an inactive duration and how long it should remain in the inactive duration. Accordingly, the devices (e.g., the UEs 115) within the wireless communications system 100 may increase power savings and reduce data traffic congestion by dynamically adapting DRX cycle transitions (e.g., via lower level signaling and machine learning models) in the wireless communications system 100.

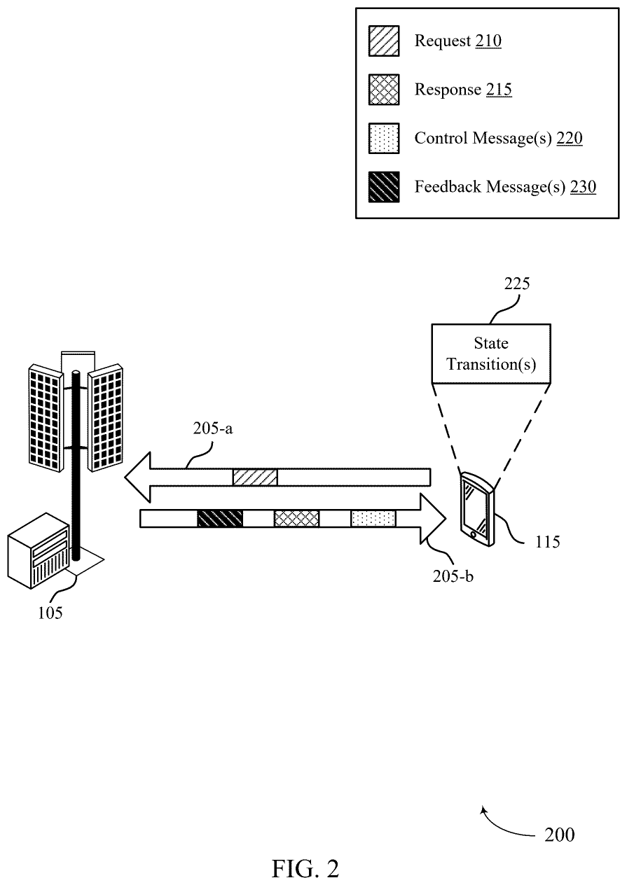

FIG. 2 shows an example of a wireless communications system 200 that supports enhanced UE state transitions and dynamic DRX procedures in accordance with one or more aspects of the present disclosure. The wireless communications system 200 may implement or be implemented by aspects of the wireless communications system 100 as described with reference to FIG. 1. For example, the wireless communications system 200 may include a UE 115 and a network entity 105, which may be examples of, or include, corresponding devices as described with reference to FIG. 1. The network entity 105 may communicate with the UE 115 via a communication link 205-a (e.g., a downlink communication channel) and a communication link 205-b (e.g., an uplink communication channel). The communication links 205 may be examples of or include downlink communication interfaces, uplink communication interfaces, or other communication interfaces. In some examples, the UE 115 and the network entity 105 may exchange signaling such as a request 210, a response 215, a control message 220, or other signaling via the communication links 205, which may enable a state transition 225 (e.g., a dynamic configuration of state transitions) at the UE 115. Although a network entity 105 and a UE 115 are shown as example devices of the wireless communications system 200, the techniques herein may be applied by one or more other devices described herein, including with reference to FIG. 1 (e.g., UEs 115, a CU 160, a DU 165, an RU 170, or other network node).

In some cases, one or more state transitions 225 (e.g., in various upper-layer procedures, associated with one or more state machines of the UE 115) may be controlled by one or more inactivity timers. The one or more state transition 225 may be associated with a DRX state (e.g., active periods of DRX, inactive periods of DRX, DRX cycle configurations), a BWP state (e.g., a type of active BWP, a narrow BWP, a wide BWP), a data activity state (e.g., RRC connected state, RRC idle state, RRC inactive state), a secondary cell state (e.g., activated secondary cell, deactivated secondary cell), or some other communication state. The one or more state transitions 225 may be based on one or more inactivity timers at the UE 115 (e.g., a DRX inactivity timer, a BWP inactivity timer, a data inactivity timer, a secondary cell deactivation timer). The UE 115 may start (e.g., initiate) an inactivity timer based on (e.g., in response to) a specified event (e.g., a triggering event, receiving an indication of a scheduled data transmission, identifying that data communication is inactive between the network entity 105 and the UE 115). In some cases, if the UE 115 does not detect any data activity (e.g., or any scheduling of data activity) prior to an expiration of the inactivity timer, the UE 115 (e.g., a higher layer procedure of the UE 115) may switch to a different state when the inactivity timer expires.

However, in some cases, the one or more inactivity timers may be configured via higher layer signaling (e.g., RRC signaling) and may be static or semi-static. Additionally, a single value of an inactivity timer may not be efficient (e.g., optimized) for all scenarios experienced by the UE 115. For instance, data traffic volumes, power status changes, and other operating conditions at the UE 115 may be dynamic (e.g., based on an application used by the UE 115), and using the single value for the inactivity timer may be relatively inefficient for at least some of the operating scenarios. Further, reconfiguration of the inactivity timer values may be associated with relatively high signaling overhead and may accordingly be updated on a relatively infrequent basis.

In accordance with one or more techniques described herein, the UE 115 and the network entity 105 may support dynamic configurations (e.g., via relatively lower layer signaling) for one or more state transitions 225 at the UE 115, which may improve efficiency associated with the one or more state transitions 225. The one or more state transitions 225 may be associated with data activity or data inactivity (e.g., triggered based on data activity not satisfying a threshold). In some examples, dynamic state transitions may include a determination by the UE 115 to make a state transition 225. The UE 115 may indicate such a determination by transmitting a request 210 (e.g., a state transition request message) to the network entity 105 (e.g., the UE 115 indicates the network entity 105 when the UE 115 wants to change its state), which may be a request to transition from a first state (e.g., an active state, a narrow BWP state, an SCell activated state) to a second state (e.g., an inactive state, a wide BWP state, an SCell deactivated state).

In some examples, the UE 115 may receive one or more control messages 220, which may configure the UE 115 to support dynamic state transitions. For example, the network entity 105 may configure (e.g., or preconfigure) a set of multiple values for a given inactivity timer via a control message 220 (e.g., or via an indication therein). Based on receiving the control message 220, the UE 115 may transmit a request 210, which may indicate an inactivity timer value (e.g., a requested value, a selected value) that the UE 115 selects to apply when an associated inactivity timer is subsequently started or restarted (e.g., in response to a subsequent triggering event). In some examples, such a request 210 may be transmitted via layer one (L1) signaling (e.g., uplink control information (UCI)), layer two (L2) signaling (e.g., medium access control control element (MAC CE)), layer three (L3) signaling (e.g., UE assistance information), or a combination thereof.

The network entity 105 may, in response to (e.g., based on, after) receiving the request 210, transmit (e.g., output, send) a response 215 (e.g., a response message, a downlink MAC CE). The response 215 may confirm the request 210 or may reject the request 210. In some examples, the network entity 105 may also use the response 215 (e.g., the MAC CE) to configure a inactivity timer value different than a requested value by the UE 115 (e.g., different that an inactivity timer value included in the request 210, if the network entity 105 disagrees with the requested value).

In some examples, the request 210 may include an explicit indication by the UE 115. In such examples, the request 210 may be transmitted via L1 signaling (e.g., UCI) or L2 signaling (e.g., MAC CE). The request 210 may include a binary indication of a state transition 225. The request 210 may additionally include an indication of a selected (e.g., preferred) next state (e.g., a selected value for an inactivity timer associated with a particular state) for the UE 115. The next state (e.g., the content of the indication included in the request 210) may be associated with various parameters (e.g., various inactivity timer values) based on a type of state transition 225 (e.g., a state context). For example, for DRX state transitions, a parameter for the next state may refer to a sleep duration (e.g., a sleep state, a duration that the UE remains in a sleep state, DRX inactive state) or otherwise indicate when the UE 115 will wake up (e.g., an awake state, a DRX active state) from a sleep state. For BWP state transitions, a next state may refer to a target BWP (e.g., narrow BWP state, wide BWP state) that the UE 115 may switch to (e.g., if the network entity 105 grants the request 210). For data inactivity state transitions (e.g., data inactivity for RRC release), a next state may refer to an RRC state (e.g., an RRC idle state, an RRC inactive state, a state after a UE 115 is released from RRC Connected state). For SCell activity state, a next state may refer to a SCell deactivation state, or, in some examples, the next state may not be specified for SCell deactivation scenarios.

After the UE 115 transmits the request 210 (e.g., the indication of a next state), the UE 115 may start a timer to wait for the network entity 105 response 215. In some examples, the timer may be associated with a same duration as a HARQ retransmission timer. The network entity 105 may configure (e.g., via one or more control messages 220) the UE 115 to autonomously makes the state transition 225 (e.g., the states transition requested by the request 210) if the UE 115 does not receive the response 215 (e.g., or any other response) prior to an expiration of the timer. For example, the UE 115 may be near a cell-center of the network entity 105 (e.g., associated with relatively high communication quality), and a likelihood that the request 210 will be successfully received at the network entity 105 may be relatively higher. Alternatively, the network entity 105 may configure the UE 115 to cancel the requested state transition 225 if UE 115 does not receive the response 215 (e.g., or any other response) from the network entity 105 prior to an expiration of the timer. For example, the UE 115 may be near a cell-edge of the network entity 105 (e.g., associated with relatively low communication quality), and a likelihood that the request 210 will be successfully received at the network entity 105 may be relatively lower.

In some examples, the network entity 105 may agree, or partially agree, with the request 210. If the network entity 105 agrees with the request 210 and the network entity 105 configures the UE 115 to autonomously make a state transition 225 (e.g., without a response 215), the network entity 105 may not transmit the response 215 (e.g., before an expiration of a timer). Alternatively, if the network entity 105 configures the UE 115 to cancel the requested state transition 225 when failing to receive the response 215, the network entity 105 may utilize the response 215 to indicate to the UE 115 (e.g., prior to an expiration of a timer) whether the network entity 105 agrees with the request 210. For example, if the network entity 105 agrees with the request 210 to perform a one or more state transitions 225 and also agrees with the indication of the next state (e.g., an inactivity timer value for the next state), the network entity 105 may transmit the response 215 via a MAC CE with no content to confirm the request 210. Such a response 215 may be compatible with either L1 signaling or L2 signaling (e.g., L1 or L2 signaling used for transmitting the request 210). Alternatively, the response 215 may be transmitted via a scheduling downlink control information (DCI) message with a same HARQ process as that of a physical uplink shared channel (PUSCH) in which the request 210 (e.g., a sleep indication) is transmitted. In such examples, the response 215 may be the same HARQ process but with a toggled new data indicator (NDI) to confirm the request 210. Such a DCI may be a DCI with no payload (e.g., a dummy DCI) and may be compatible with L2 signaling (e.g., L2 signaling used for transmitting the request 210).

If the network entity 105 agrees with the request 210 to perform a state transition 225 but disagrees with the indicated next state (e.g., the network entity 105 partially agrees with the request 210), the network entity 105 may transmit the response 215 (e.g., via a MAC CE) that includes a next state different from what the UE 115 requested (e.g., a different inactivity timer value). Accordingly, based on receiving such a response 215, the UE 115 may comply with the next state as indicated by the network entity 105. If the network entity 105 disagrees with the request 210, the network entity 105 may transmit the response 215 via a scheduling DCI for a new transmission (e.g., which may not match a HARQ process associated with the request 210). Such a DCI may not include a payload (e.g., a dummy DCI). Based on receiving such a response 215, the UE 115 may cancel its request to perform a state transition 225.

In some examples, the control message 220 may configure a timer that controls how often UE 115 may transmit the request 210 (e.g., state transition requests). When configured, such a timer may be started when the UE 115 transmits the request 210 to the network entity 105. The UE 115 may not transmit another request 210 to perform a state transition 225 until the timer expires.

In some examples, the UE 115 may determine when to transmit the request 210 (e.g., when to make a state transition 225) based on a machine learning model (e.g., AI engine(s), an AI model, a neural network). For example, an AI engine at the UE 115 may collect uplink traffic arrivals (e.g., such as inter-arrival time), a type of each protocol data unit (PDU) (e.g., control vs data), or other information, and may predict when a data burst may end. The AI engine may also perform a same prediction on downlink traffic. In some examples, the UE 115 may request a state transition 225 when the AI engine detects a change in traffic characteristics that may be more efficiently handled in a different state. For example, for a DRX inactivity, data inactivity, or SCell deactivation, among other examples, when an inter-arrival time of next data is greater (e.g., longer) than a threshold (e.g., long enough for the UE 115 to have a meaningful sleep), the AI engine may indicate the UE 115 to transmit a request 210. In another example, for BWP inactivity, when a data rate increases above a threshold (e.g., a preset threshold) or decreases below a threshold, the AI engine may indicate the UE 115 to transmit a request 210.

Additionally, the network entity 105 may provide one or more feedback messages 230 to the UE 115 to improve (e.g., train) the machine learning model. In some examples, the network entity 105 may collect statistics on one or more requests 210 received from the UE 115. For example, the network entity 105 may monitor how often the request 210 is transmitted too late or too early (e.g., relative to a threshold) and may indicate a distribution of such errors in a feedback message 230. In particular, for a DRX procedure, the network entity 105 may monitor how often the UE 115 wakes up too early or too late and may indicate a distribution of such errors. For a BWP switching scenario, the network entity 105 may monitor and indicate how often the UE 115 chooses a correct (e.g., or incorrect) next BWP (e.g., based on a chosen BWP matching or not matching with corresponding data traffic characteristics such as traffic volume or data rates). For an RRC state transition, the network entity 105 may monitor and indicate how often the UE 115 makes a correct (e.g., or incorrect) decision between an RRC inactive state and an RRC idle state. Accordingly, the network entity 105 may provide such statistics back to the UE 115 via the one or more feedback messages 230, which the UE 115 may use to train its AI engine(s).

Accordingly, by communicating one or more control messages 220, a request 210, a response 215, and one or more feedback messages 230, the wireless communications system 200 may support increased energy savings, enhanced coordination between devices, and improved data rates, among other benefits. For example, the UE 115 may be enabled to more quickly respond to changes in its environmental and traffic conditions, allowing the UE 115 to conserve more power or improve data rates for longer durations.

In some cases, a DRX configuration may control when the UE 115 operates in an active state (e.g., monitors for physical downlink control channel (PDCCH) messages or physical downlink shared channel (PDSCH) messages) and when the UE 115 operates in an inactive state (e.g., how long the UE 115 remains in a sleep state). In other words, the DRX configuration may control time resources of when the UE transitions a sleep state and a duration that the UE 115 is to remain in the sleep sate (e.g., or time resources when the UE 115 is to wake up). In some cases, such DRX configurations may be static or semi-static, which may be associated with relatively high signaling overhead to configure (e.g., or reconfigure).

Specifically, a DRX inactivity timer parameter (e.g., configured by RRC and/or semi-static configuration) of DRX configuration may control when the UE 115 transitions to an inactive period of DRX (e.g., when to go to sleep). Additionally, a DRX cycle parameter (e.g., configured by RRC and/or semi-static configuration) of a DRX configuration may control a duration of one or more inactive periods of the DRX cycle (e.g., how long the UE 115 remains in sleep). A timer parameter of the DRX configuration (e.g., a short DRX cycle timer, also configured by RRC and/or semi-static configuration) may control which DRX cycle the UE 115 is to use. However, such cases of DRX configurations and DRX parameters may be associated with relatively higher layer configurations of the wireless communications system 200 (e.g., RRC configurations).

Accordingly, adjusting the DRX configurations and parameters may be associated with relatively high signaling overhead, which may increase data traffic and latency. Moreover, a single DRX configuration (e.g., a single value for DRX timers) that is applied for a broad range of applications may be relatively inefficient for at least some applications. For example, data traffic levels may be dynamic (e.g., resulting in relatively higher or lower activity by the UE 115) and the UE 115 may experience various power status changes, and a single DRX configuration may not suit all conditions of the wireless communications system 200 experienced by the UE 115.

In accordance with one or more techniques described herein, a UE 115 and a network entity 105 may support more-dynamic DRX configuration mechanisms to improve power efficiency, and enable the wireless communications system 200 to be relatively more reliable (e.g., stable) across diverse communication conditions. For example, the UE 115 may transmit (e.g., send, output, indicate) a request 210 (e.g., a go-to-sleep request, a DRX transition request message) and may receive (e.g., obtain, identify) one or more control messages 220 (e.g., control indications), a response 215 (e.g., a response message), and one or more feedback messages 230, which may enable one or more DRX transitions (e.g., entering a sleep state) at the UE 115.

In some examples, the network entity 105 may configure (e.g., preconfigure, via an indication of the one or more control messages 220) one or more DRX inactive timer values of a DRX inactivity timer for selection (e.g., choice) by the UE 115. The UE 115 may then use various signaling mechanisms to indicate a particular DRX inactivity timer value to apply for a subsequent DRX inactivity timer (e.g., when a next timer is started or restarted). For example, the UE 115 may indicate the requested DRX inactivity timer value via layer one (L1) signaling (e.g., uplink control information (UCI)), layer two (L2) signaling (e.g., a medium access control control element (MAC CE)), layer three (L3) signaling (e.g., UE assistance information), or other signaling. If the UE 115 uses L1 signaling or L2 signaling, the network entity 105 may transmit the response 215 via a downlink MAC CE (e.g., after receiving the request 210). The response 215 may confirm, partially confirm, or reject the request 210. For example, the network entity 105 may indicate, via the response 215, a different DRX inactivity timer value (e.g., than what was indicated in the request 210). In such an example, the UE 115 may apply the value that was indicated by the network entity 105 via the response 215. Alternatively, if the UE 115 uses L3 signaling, the network entity 105 may transmit the response 215 via an RRC reconfiguration, which may set a new timer value for the UE 115.

In some examples, the request 210 may include an explicit indication by the UE 115. For example, the request 210 may include an indication that the UE 115 is going to transition to an inactive period of a DRX cycle (e.g., DRX inactive period, going to sleep). The request 210 (e.g., transmitted via L1 or L2 signaling) may further include a duration for the inactive period that is determined (e.g., preferred) by the UE 115. In some examples, after the UE 115 transmits the request 210, the UE 115 may start a timer to wait for a response 215 from the network entity 105. The timer may, in some examples, be the same as a HARQ retransmission timer (e.g., of the DRX configuration). The network entity 105 may configure, via the one or more control messages 220, the UE 115 to perform (e.g., autonomously) a state transition 225 (e.g., a DRX transition) to an inactive period (e.g., enters sleep) if the UE 115 does not receive the response 215 prior to an expiration of the timer. For example, the UE 115 may be relatively close to a cell center, and the UE 115 may assume that the request 210 is successfully received by the network entity 105. Alternatively, the network entity 105 may configure the UE 115 to refrain from performing the state transition 225 (e.g., to stay active) if the UE 115 does not receive the response 215 from the network entity 105 by expiry of the timer.

If the network entity 105 agrees with the request 210 and the UE 115 is configured to autonomously perform the state transition 225 based on transmitting the request, the network entity 105 may not transmit the response 215. Alternatively, if the network entity 105 agrees with the request 210 and the UE 115 is configured to wait for a response 215 before performing a state transition 225, the network entity 105 may transmit the response 215 (e.g., via a MAC CE) to confirm the request 210. In some examples, if the MAC CE of the response 215 does not include any content, the response 215 may indicate that the network entity 105 agrees with request 210. In some examples, if the response 215 includes a sleep duration that is different from what the UE 115 requested, the response 215 may indicate that the network entity 105 agrees with request 210 to the DRX transition but wants the UE 115 to apply a different sleep duration. In such an example, the UE 115 may comply with the sleep duration indicated by the network entity 105.

If the network entity 105 does not agree with the request 210, the network entity 105 may transmit a scheduling downlink control information (DCI) message for a new HARQ transmission. Such a DCI may schedule a transport block (TB) without a payload (e.g., a dummy TB) if the network entity 105 has no new data to send. Based on receiving such a response 215 (e.g., after reception of the DCI), the UE 115 may cancel its request 210 (e.g., its DRX transition request).

In some examples, the network entity 105 may configure (e.g., preconfigure), via the one or more control messages 220, several values of a DRX cycle that the UE 115 may select from. In such examples, the UE 115 may indicate (e.g., via the request 210) which of the DRX cycle values to use when (e.g., prior to) entering a sleep state (e.g., an inactive period of the DRX cycle). For example, the UE 115 may wake up at a time location (e.g., a time resource) determined based on a DRX configuration (e.g., a DRX formula) using an indicated DRX cycle value (e.g., indicated via either by the UE 115 or the network entity 105). Additionally, or alternatively, the UE 115 may directly indicate a duration for an inactive period of the DRX cycle. For example, the UE 115 may wake up at a time resource (e.g., time location) that is equal to a time at which the request 210 is transmitted (e.g., a current time) plus a duration included in the request 210 (e.g., the requested sleep duration, the sleep duration indicated via the response 215 by the network entity 105). In such examples, a requested sleep duration may be included in each request 210 from the UE 115.

Additionally, or alternatively, the UE 115 may be configured with a DRX cycle (e.g., via the one or more control messages 220) that includes a set of active and inactive periods. The UE 115 may use the DRX cycle configurations to determine the starting points of each subsequent on duration (e.g., active periods) of the DRX cycle. In such examples, the UE 115 may indicate, via the request 210, in which active periods (e.g., on durations) that the UE wakes up. The UE 115 may indicate a parameter that identifies a subset of active periods of the DRX cycle in which the UE 115 will activate (e.g., which may be less than a total quantity of active periods in the DRX cycle). For example, the UE 115 may indicate an integer multiple of active periods from a current time (e.g., a second on duration from the current time). Accordingly, the network entity 105 may not configure a separate short DRX cycle and a long DRX cycle. Additionally, such examples may eliminate a transition mechanism between a short DRX cycle and a long DRX cycle. Further, in such examples, the network entity 105 may configure (e.g., via RRC) a default sleep duration if it is not included in the request 210.

The UE 115 may support several options for operation after transitioning to an active period of DRX. In a first option, the UE 115 may start a DRX active timer (e.g., a DRX on duration timer) after it wakes up (e.g., transitions to an active period of the DRX cycle). If downlink or uplink data is communicated during a DRX active period, the UE 115 may enter an active time (e.g., the UE 115 stays on and continuously monitors PDCCH) until the UE 115 requests to go to sleep (e.g., transmits a request 210) and is put to sleep by the network entity 105 (e.g., via a response or absence of response). The UE 115 may transition back to an inactive period (e.g., go back to sleep) if there is no uplink or downlink data when an active timer (e.g., on duration timer) expires. In some examples, the UE may use a default sleep duration as configured by the network entity 105. In some examples, the UE 115 may determine (e.g., choose) to send the request 210 (e.g., a go-to-sleep indication) with a selected sleep duration while the UE 115 operates in an active period (e.g., during on duration). In such examples, the requested sleep duration may start after an end of a current active period (e.g., the UE 115 may not request an early termination of the current on duration).

Alternatively, in a second option, the UE 115 may not use an active timer. For example, when the UE 115 wakes up, the UE 115 may remain in an active period of DRX (e.g., and monitor PDCCH) until the UE 115 determines that it should transition to an inactive period of DRX (e.g., and transmits a request 210) or until the network entity 105 transmits a response 215 (e.g., a DRX MAC CE) to send the UE to the inactive period. In such examples, the UE 115 may transmit a request 210 for each transition to the inactive period (e.g., even when the UE 115 does not have uplink data to communicate with the network entity 105 and would thus not otherwise transmit an uplink transmission).

In some examples, the UE 115 may operate in accordance with the first option if the network entity 105 configures an active timer (e.g., on duration timer) in the DRX configuration. In some examples, the UE 115 may operate in accordance with the second option if the network entity 105 does not configure an active timer in the DRX configuration. Additionally, or alternatively, the network entity 105 may indicate, via the response 215, (e.g., or the UE 115 may indicate via the request 210) whether the UE 115 is to operate in accordance with the first option or the second option when transitioning to an active period.

Additionally, in some examples, the UE 115 may be configured such that the UE 115 may not transmit a request 210 to reduce signaling traffic. To further reduce signaling traffic, the network entity 105 may configure (e.g., RRC configure) a default sleep duration (e.g., if it is not included in the request 210). Additionally, or alternatively, a sleep duration that is confirmed or provided by the network entity 105 may be persistent. That is, the sleep duration may be used if a subsequent request 210 does not include a requested sleep duration (e.g., the UE 115 may apply a previously indicated sleep duration for multiple inactive periods of DRX).

The UE 115 may use a machine learning model (e.g., AI engine(s), a neural network) to help make determinations (e.g., decisions) on when to transition to an inactive period and how long it should remain in the inactive period. For example, an AI engine at the UE 115 may collect uplink traffic arrivals, such as inter-arrival time and a type of each PDU (e.g., control vs data), and predict when a data burst may end. The AI engine may perform a same prediction on downlink traffic. The UE 115 may transmit the request 210 (e.g., request go-to-sleep) when the AI engine has relatively high confidence (e.g., determines a relatively high probability) that both downlink and uplink traffic have stopped or may stop within a threshold duration. For example, the inter-arrival time (e.g., or a prediction thereof) of next data may longer than a threshold (e.g., long enough for UE to have a meaningful sleep), and the AI engine may trigger the UE 115 to transmit a request 210. In some examples, the AI engines may also predict when a next downlink data burst arrives. Such a prediction may allow the UE 115 to determine how long it can remain in an inactive period of DRX. The prediction may be based on one or more statistics of past inter-arrival times of downlink data bursts.

In some examples, the network entity 105 may transmit one or more feedback messages 230 to improve the machine learning model at the UE 115. For example, the network entity 105 may collect statistics on one or more requests 210, and may report the statistics to the UE 115. The statistics may include an error distribution of how often the requests 210 have been made too late or too early (e.g., defined by one or more threshold values). The statistics may also include an error distribution associated with the requested duration of an inactive period (e.g., how often UE wakes up too early or too late, defined by one or more threshold values). Accordingly, the network entity 105 may provide such statistics back to the UE 115 via the one or more feedback messages 230, which the UE 115 may use to train its machine learning model (e.g., AI engines). The one or more feedback messages 230 may further include statistics associated with a scheduling behavior of the network entity 105.

Accordingly, by communicating one or more control messages 220, a request 210, a response 215, and one or more feedback messages 230, the wireless communications system 200 may support state transitions 225 (e.g., dynamic DRX transitions), which may increase energy savings and enhance coordination between devices. For example, the UE 115 may be enabled to more-quickly respond to data traffic fluctuations, allowing the UE 115 to remain in inactive periods of DRX for relatively longer durations and increase energy savings.

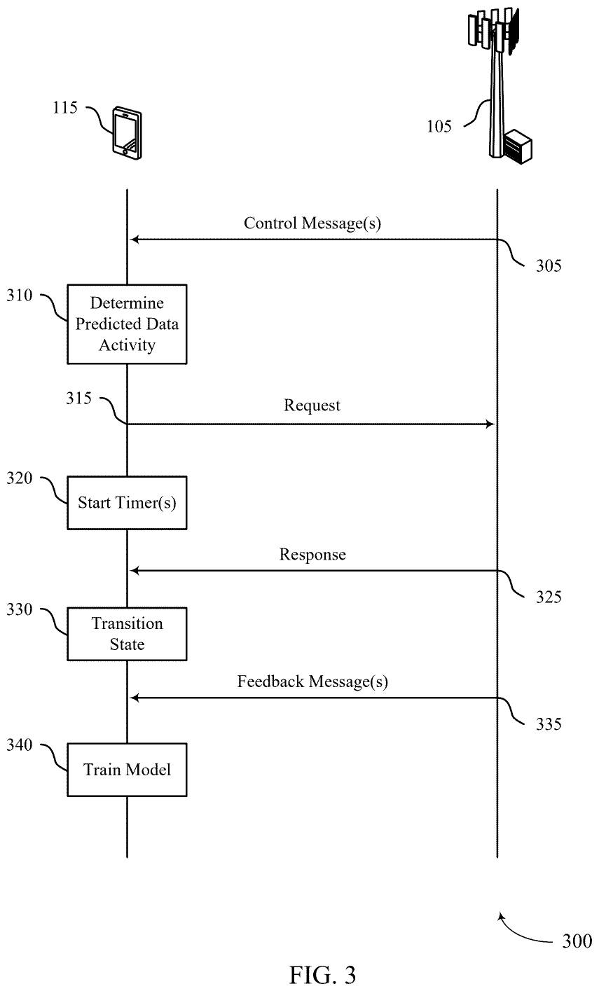

FIG. 3 shows an example of a process flow 300 that supports enhanced UE state transitions in accordance with one or more aspects of the present disclosure. In some examples, the process flow 300 may implement aspects of the wireless communications system 100 and the wireless communications system 200. For example, the process flow 300 may support signaling between a UE 115 and a network entity 105 to enable dynamic state transitions at the UE 115. The UE 115 and the network entity 105 of the process flow 300 may be examples of corresponding devices herein, including with reference to FIGS. 1 and 2. In the following description of the process flow 300, the operations between the UE 115 and the network entity 105 may be performed in a different order than the order shown, or other operations may be added or removed from the process flow 300. For example, some operations may also be left out of the process flow 300, or may be performed in different orders or at different times. Further, although some operations or signaling may be shown to occur at different times for discussion purposes, these operations may actually occur at the same time. Although the UE 115 and the network entity 105 are shown performing the operations of the process flow 300, some aspects of some operations may also be performed by one or more other wireless or network devices.

At 305, the UE 115 may receive, from the network entity 105, an indication (e.g., a control message 220) of a set of inactivity timer values for an activity timer associated with a transition from a first state at the UE 115 to a second state at the UE 115. For example, the set of inactivity timer values may be preconfigured and may be indicated to the UE 115 via one or more control messages. In some examples, the UE 115 may receive a control message (e.g., a control message 220) from the network entity 105 that configures whether the UE 115 is to transition from a first state to a second state based on an expiration of a timer (e.g., the UE 115 may autonomously transition states) or to refrain from transitioning from the first state to the second state based on the expiration of the timer (e.g., wait until receiving a response prior to transitioning states). Additionally, or alternatively, the UE 115 may receive a control message that configures a timer associated with transmitting a state transition request (e.g., a request 210) or a timer associated with receiving a response (e.g., a response 215) from the network entity 105.

At 310, in some examples, the UE 115 may determine a predicted data activity between the UE 115 and the network entity 105. The predicted data activity may be based on a machine learning model (e.g., AI engine(s), neural network) at the UE 115. For example, the UE 115 may collect traffic arrival times, PDU types, or other metrics and may use such metrics to predict future data activity. In some examples, the UE 115 may determine to transmit a state transition request message based on the machine learning model.

At 315, the UE 115 may transmit, to the network entity 105 and while operating in a first state, a request (e.g., a state transition request, a request 210) to transition from the first state to a second state based on data activity between the UE 115 and the network entity 105. In some examples, the request to transition from the first state to the second state may include a requested value (e.g., an explicit request by the UE 115) for an inactivity timer at the UE 115 (e.g., a DRX inactivity timer, a BWP inactivity timer, a data inactivity timer, an SCell deactivation timer). Alternatively, the request may include an indication of an inactivity timer value that is selected from the set of inactivity timer values, which were indicated (e.g., configured) in the one or more control messages (e.g., at 305). That is, the UE 115 may select an inactivity timer value based receiving the indication of the set of inactivity timer values.

In some examples, the UE 115 may transmit, via the request, an indication of a requested state for the second state. The requested state may be associated various states such as a sleep state, an awake state, a state associated with a target BWP, an RRC state, a state associated with a deactivation of a SCell, some other state or any combination thereof. In some examples, the UE 115 may transmit the request based on predicted data activity (e.g., from a machine learning model) satisfying a threshold.

In some examples, the UE 115 may transmit multiple subsequent state transition requests (e.g., may apply one or more operations of the process flow 300 multiple times). For example, the UE 115 may operate in a third state and transmit a second request to transition from the third state to a fourth state based on data activity between the UE 115 and the network entity 105. In some examples, the UE 115 may refrain from transmitting a second request to transition states prior to an expiration of the timer associated with transmitting the request (e.g., transmitting subsequent requests).

At 320, the UE 115 may start one or more timers based on transmitting the request. In some examples, a first timer may be associated with receiving a response message from the network entity 105 (e.g., a duration in which the UE 115 expects to receive the response message). Additionally, or alternatively, the UE 115 may start a second timer associated with transmitting the request (e.g., a duration during which the UE 115 waits before transmitting a subsequent state transition request) based transmitting the request.

At 325, the UE 115 may receive a response message (e.g., a response 215) from the network entity 105. In some examples, the UE may receive the response message based on receiving the one or more control messages, transmitting the request to the network entity 105, or both. In some examples, the response message may indicate that the request is accepted by the network entity 105. Additionally, or alternatively, the response message may indicate an inactivity timer value of the set of inactivity timer values (e.g., preconfigured values) that is different than the inactivity timer value requested by the UE. In such examples, the UE 115 may use the inactivity timer value from the response to transition from the first state to the second state. In some examples, the response message may indicate a particular state that the UE is to transition to (e.g., may indicate the second state). In some examples, the UE 115 may receive a response message that indicates that the request is rejected by the network entity 105. The UE 115 may receive the response message from the network entity 105 prior to the expiration of the timer associated with the response message.

At 330, the UE 115 may transition from the first state to the second state (e.g., perform a state transition 225) based on transmitting the request, based on an expiration of the inactivity timer, based on the UE 115 may receive the response message, or any combination thereof. Alternatively, the UE 115 may refrain transitioning from a first state to a second state based on receiving a response message that rejects the request by the UE 115.

In some examples, the UE 115 may transition, in accordance with the control message (e.g., indicating a first configuration), from the first state to the second state based on failing to receive the response message from the network entity 105 prior to the expiration of the timer (e.g., an autonomous state transition). Alternatively, the UE 115 may transition, in accordance with the control message (e.g., indicating a second configuration), from the first state to the second state based on receiving the response message (e.g., the UE 115 may wait to make a requested transition until receiving the response). Additionally, the UE 115 may transition from the first state to the second state in accordance with a target state indicated by the network entity 105 based on receiving the response message.

At 335, the UE 115 may receive, based on transmitting the request, a feedback message (e.g., a feedback message 230) from the network entity 105 that is associated with the request. In some examples, the feedback message may include an error distribution associated with state transitions that are incorrectly performed (e.g., earlier than a time threshold, later than a time threshold, an incorrect state). A given error distribution of the feedback message may be based on a type of state transitions that the UE is performing.

At 340, the UE 115 may train the machine learning model based on the feedback message received from the network entity 105. For example, the UE 115 may use the error distribution statistics associated with its state transition requests to update the model, which may enable the UE 115 to improve its predictions and more accurately transmit state transition requests to the network entity 105.

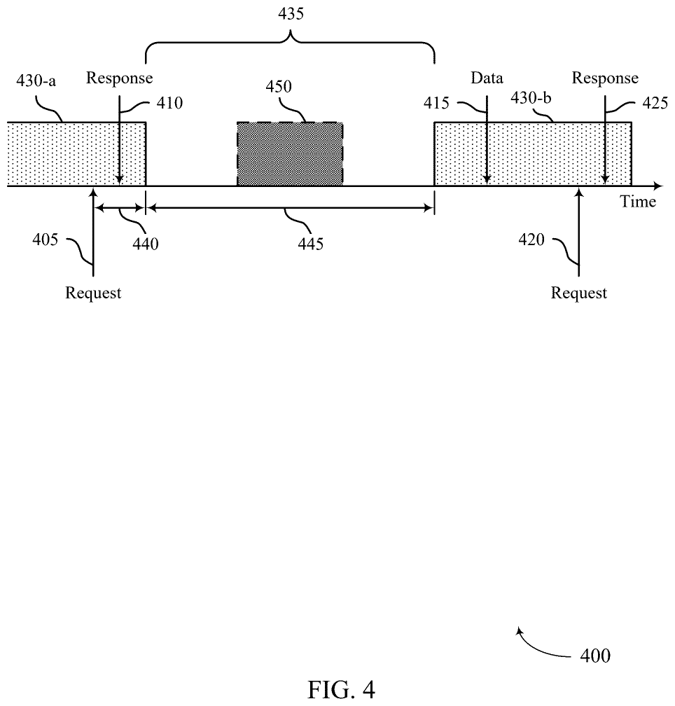

FIG. 4 shows an example of a DRX cycle 400 that supports dynamic DRX procedures in accordance with one or more aspects of the present disclosure. The DRX cycle 400 may illustrate a non-limiting example of a signaling sequence between a UE 115 and a network entity 105 in accordance with techniques described herein, including with reference to FIGS. 1 and 2. For example, the DRX cycle 400 may show multiple active periods 430 of the DRX cycle, as well as various messages (e.g., at 405, at 410, etc.) over a time axis (e.g., along the horizontal axis). Additionally, although FIG. 4 shows a non-limiting example signaling sequence, the DRX cycle 400 may occur over any duration of time (e.g., including for more or less time than shown) and may include any quantity of requests, responses, data, and other signaling, which may occur at different times and sequences than shown.

At 405, a UE 115 may transmit a request (e.g., a request 210, a go-to-sleep request) to a network entity 105. The request may be transmitted during an active period 430-a of the DRX cycle 400 (e.g., prior to an expiration of an inactivity timer). In some examples, the UE 115 may initiate a timer associated with a duration 440 (e.g., a HARQ round trip time (RTT) timer, a timer associated with receiving a response from the network entity 105). At 410, the UE 115 may receive a response (e.g., a response 215, a confirm MAC CE) from the network entity 105 (e.g., within the active period 430-a), which may confirm the request. Based on receiving the response, the UE 115 may transition to an inactive period 435 of the DRX cycle 400, which may be associated with a duration 445 (e.g., a sleep duration). In the example of the DRX cycle 400, the UE 115 may have indicated the duration 445 via the request, or may have received an indication of the duration 445 via the response from the network entity 105. The duration 445 may be a different duration (e.g., a longer duration) relative to a duration configured for the DRX cycle 400 (e.g., via higher layer signaling). Accordingly, the UE 115 may refrain from activating for (e.g., may skip) an active period 450 of the DRX cycle 400 based on transmitting the request, receiving the response, or both.

Following the duration 445, the UE 115 may transition to an active period 430-b of the DRX cycle 400. At 415, the UE 115 may receive data, which may trigger a DRX inactivity timer, and the UE 115 may continue to monitor for further downlink signaling (e.g., PDCCH, PDSCH). Following a data exchange, the UE 115 may determine (e.g., based on a machine learning model) that there is no more uplink data or downlink data to communicate. Accordingly, at 420, the UE 115 may transmit a second request to transition to an inactive period of the DRX cycle 400. In some examples, the second request may include a different duration than the duration 445, or may not include any indication of a duration. If the second request does not include an indicated duration, the UE 115 may be configured to use (e.g., reuse) the duration 445 for a subsequent inactive period of the DRX cycle. At 425, the UE 115 may receive a second response from the network entity 105 that accepts, partially accepts, or rejects the second request.

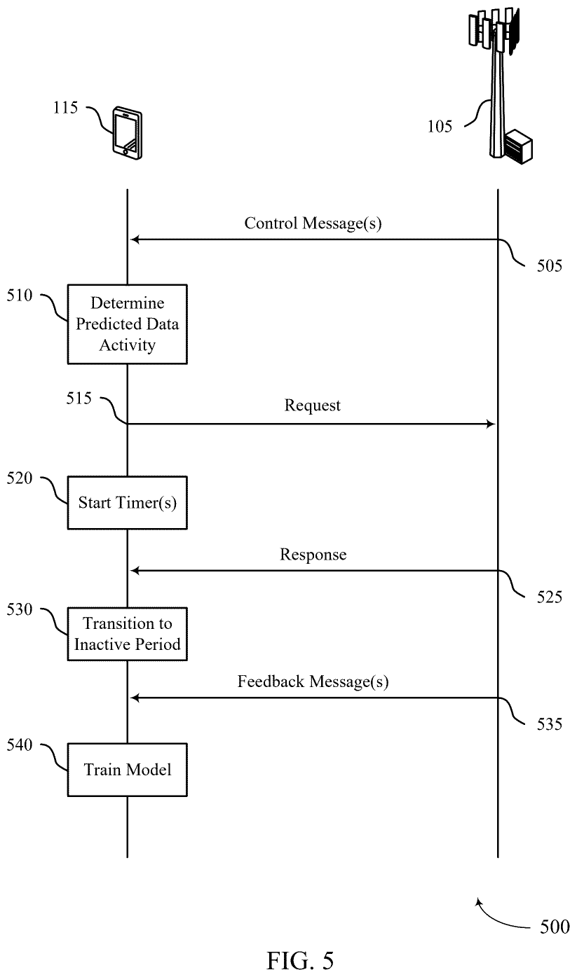

FIG. 5 shows an example of a process flow 500 that supports dynamic DRX procedures in accordance with one or more aspects of the present disclosure. In some examples, the process flow 500 may implement aspects of the wireless communications system 100, the wireless communications system 200, and the DRX cycle 400. For example, the process flow 500 may support signaling between a UE 115 and a network entity 105 to enable dynamic DRX transitions.

The UE 115 and the network entity 105 of the process flow 500 may be examples of corresponding devices herein, including with reference to FIGS. 1 through 3. In the following description of the process flow 500, the operations between the UE 115 and the network entity 105 may be performed in a different order than the order shown, or other operations may be added or removed from the process flow 500. For example, some operations may also be left out of the process flow 500, or may be performed in different orders or at different times. Further, although some operations or signaling may be shown to occur at different times for discussion purposes, these operations may actually occur at the same time. Although the UE 115 and the network entity 105 are shown performing the operations of the process flow 500, some aspects of some operations may also be performed by one or more other wireless or network devices.

At 505, the UE 115 may receive, from the network entity 105, one or more control messages (e.g., one or more control messages 220 configuring the UE with one or more information elements). In some examples, a control message may include an indication of a set of DRX inactivity timer values associated with transitioning, by the UE 115, to an inactive period of a DRX cycle. In some examples, the UE 115 may receive a control message from the network entity 105 that configures whether the UE 115 is to transition to an inactive period of a DRX cycle based on an expiration of a timer or to refrain from transitioning to the inactive period of the DRX cycle based on the expiration of the timer. In some examples, such a timer may be associated with receiving a response message (e.g., a response 215) from the network entity 105 (e.g., a response timer).

In some examples, the UE 115 may receive, from the network entity 105 (e.g., via a control message), an indication of a set of one or more DRX cycle configurations. An indication of a DRX cycle configuration may include a set of active periods (e.g., on durations) and a set of inactive periods (e.g., sleep durations). In some examples, the UE 115 may receive a control message that configures a timer associated with transmitting a request (e.g., a request 210, a go-to-sleep request). In some examples, the UE 115 may receive a control message that configures a default duration (e.g., a default sleep duration, a default timer value) for the UE 115 to use for an inactive period of a DRX cycle.

At 510, in some examples, the UE 115 may determine a predicted data activity between the UE 115 and the network entity 105. The predicted data activity may be based on a machine learning model (e.g., AI engine(s), a neural network) at the UE 115. For example, the UE 115 may collect traffic arrival times, PDU types, or other metrics and may use such metrics to predict future data activity. In some examples, the UE 115 may determine to transmit a request for a DRX transition based on the machine learning model.

At 515, the UE 115 may transmit, to the network entity 105 and within an active period of a DRX cycle, a request to transition to an inactive period (e.g., a sleep state) of the DRX cycle based on data activity (e.g., based on data activity not satisfying a threshold) between the UE 115 and a network entity 105. In some examples, the request may include an indication of a first DRX inactivity timer value of a set of DRX inactivity timer values (e.g., configured via a control message). The first DRX inactivity timer value may be selected (e.g., chosen) by the UE 115 based on receiving the indication of the set of DRX inactivity timer values from the network entity 105.

In some examples, the UE 115 may transmit, via the request, an indication of a duration (e.g., a requested sleep duration) associated with the inactive period of the DRX cycle. In some examples, the request may include a first DRX cycle configuration of a set of DRX cycle configurations (e.g., indicated by the network entity 105). The first DRX cycle configuration may be selected by the UE 115 based on receiving the indication of the set of DRX cycle configurations. In some examples, the request may include a parameter that identifies a subset of active periods of a set of active periods (e.g., indicated by the network entity 105 via a DRX cycle configuration) within which the UE 115 is active (e.g., awake). In some examples, the UE 115 may transmit the request based on the predicted data activity (e.g., of the machine learning model) satisfying a threshold.

In some examples, the UE 115 may transmit multiple subsequent requests (e.g., may apply one or more operations of the process flow 500 multiple times). For example, the UE 115 may transmit, within a second active period of a DRX cycle, a second request to transition to a second inactive period of the DRX cycle based on data activity between the UE 115 and the network entity 105. In some examples, the UE 115 may refrain from transmitting a second request to transition to a second inactive period of the DRX cycle prior to an expiration of a timer associated with transmitting the request (e.g., transmitting subsequent requests) based on receiving the control message.

At 520, the UE 115 may start one or more timers based on transmitting the request. In some examples, a first timer may be associated with the receiving a response message from the network entity 105 (e.g., which may be the same as a HARQ retransmission timer or a HARQ RTT timer). Additionally, or alternatively, the UE 115 may start a second timer associated with transmitting the request (e.g., a duration during which the UE 115 waits before transmitting a subsequent request) based transmitting the request.

At 525, the UE 115 may receive a response message (e.g., a response 215) from the network entity 105. In some examples, the UE 115 may receive the response message based receiving the one or more control messages, transmitting the request, or both. In some examples, the response message may indicate that the request is accepted by the network entity 105. Additionally, or alternatively, the response message may indicate a second DRX inactivity timer value of the set of DRX inactivity timer values (e.g., preconfigured values), which may be different from an DRX inactivity timer value indicated by the UE. The UE 115 may use the second inactivity timer value to transition to the inactive period of the DRX cycle. In some examples, the UE 115 may receive a response message from the network entity 105 that indicates that the request is rejected by the network entity 105. In some examples, the UE 115 may receive the response message from the network entity 105 prior to the expiration of a timer and the response message may include an indicated duration that the UE 115 is to use for the inactive period of the DRX cycle.

In some examples, the UE 115 may receive a response message based on the transmitting the request prior to transitioning to the inactive period. The response message may indicate (e.g., configure) whether the UE 115 is to transition to an inactive period of the DRX cycle in accordance with an active timer value (e.g., an expiration of an on duration timer) or is to refrain from transitioning to the inactive period of the DRX cycle until transmitting a request.

At 530, the UE 115 may transition to the inactive period of the DRX cycle (e.g., perform a state transition 225 such as a DRX transition) based on transmitting the request, receiving the response message, or both. In some examples, the UE 115 may refrain from transitioning (e.g., cancel a transition) to an inactive period of the DRX cycle based on receiving a rejection via the response message. In some examples, the UE 115 may transition, in accordance with the control message, to the inactive period of the DRX cycle based on failing to receive a response message from the network entity 105 prior to the expiration of a timer (e.g., associated with waiting for a response message, the UE 115 may be configured to autonomously transition without a response). Alternatively, the UE 115 may transition, in accordance with the control message, to the inactive period of the DRX cycle based on receiving the response message.

In some examples, the UE 115 may determine, based on a presence of an active timer value in a configuration of the DRX cycle, to transition to the inactive period of the DRX cycle in accordance with an active timer value (e.g., a configured active period duration). Alternatively, the UE 115 may determine, based on an absence of an active timer value in a configuration of the DRX cycle, to refrain from transitioning to an inactive period of the DRX cycle until the UE 115 transmits a request to transition to an inactive period or until the UE 115 receives a command to transition from the network entity 105. In some examples, the UE 115 may use a default duration for the inactive period based on an absence of a duration from the request. In some examples, for a first inactive period and at least a second inactive period of the DRX cycle, the UE 115 may use a first duration that is indicated via the request, or via a response message from the network entity 105. The UE 115 may use the first duration for multiple inactive periods based on an absence of a duration from a request to transition to the inactive period.

At 535, the UE 115 may receive, based on transmitting the request, a feedback message (e.g., a feedback message 230) from the network entity 105 that is associated with the request. In some examples, the feedback message may include an error distribution associated with the request (e.g., earlier than a time threshold, later than a time threshold, errors associated with waking up and/or going to sleep outside of a threshold).

At 540, the UE 115 may train a machine learning model based on the feedback message received from the network entity 105. For example, the UE 115 may use the error distribution statistics associated with requests to update the model, which may enable the UE 115 to improve its predictions and more-accurately transmit requests to the network entity 105.

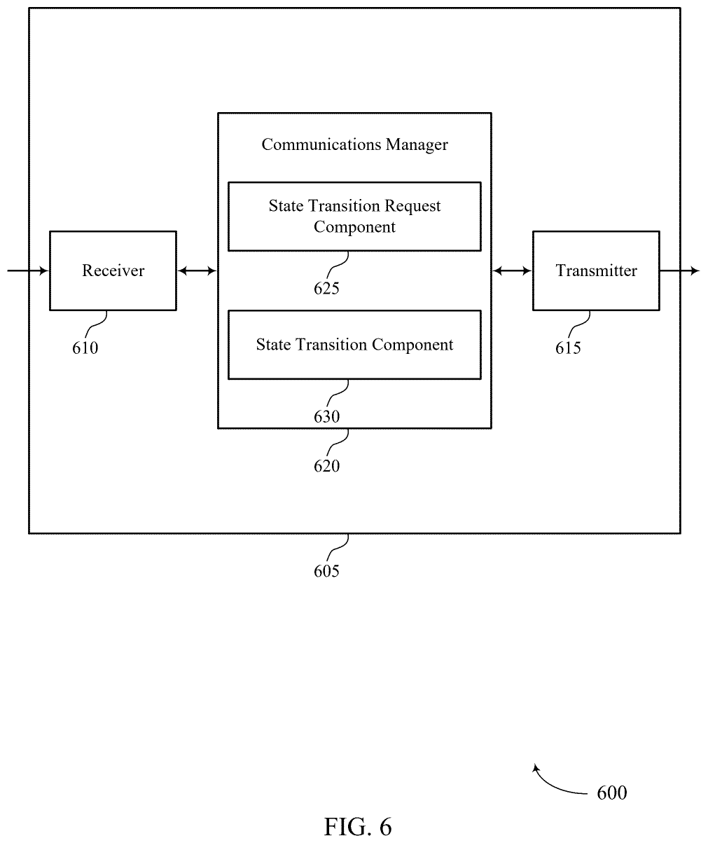

FIG. 6 shows a block diagram 600 of a device 605 that supports enhanced UE state transitions in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to enhanced UE state transitions). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to enhanced UE state transitions). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of enhanced UE state transitions as described herein. For example, the communications manager 620 may include a state transition request component 625 a state transition component 630, or any combination thereof. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The state transition request component 625 is capable of, configured to, or operable to support a means for transmitting, to a network entity and while operating in a first state, a request to transition from the first state to a second state based on data activity between the UE and the network entity. The state transition component 630 is capable of, configured to, or operable to support a means for transitioning from the first state to the second state based on transmitting the request.

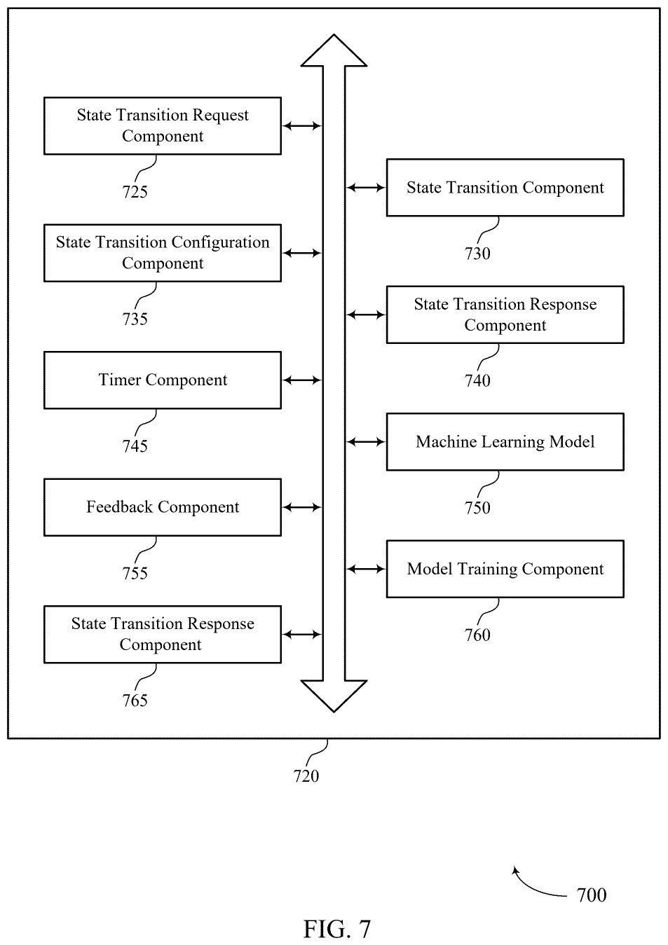

FIG. 7 shows a block diagram 700 of a communications manager 720 that supports enhanced UE state transitions in accordance with one or more aspects of the present disclosure. The communications manager 720 may be an example of aspects of a communications manager 620, as described herein. The communications manager 720, or various components thereof, may be an example of means for performing various aspects of enhanced UE state transitions as described herein. For example, the communications manager 720 may include a state transition request component 725, a state transition component 730, a state transition configuration component 735, a state transition response component 740, a timer component 745, a machine learning model 750, a feedback component 755, a model training component 760, a state transition response component 765, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The state transition request component 725 is capable of, configured to, or operable to support a means for transmitting, to a network entity and while operating in a first state, a request to transition from the first state to a second state based on data activity between the UE and the network entity. The state transition component 730 is capable of, configured to, or operable to support a means for transitioning from the first state to the second state based on transmitting the request.

In some examples, the request to transition from the first state to the second state includes a requested value for an inactivity timer at the UE. In some examples, the UE transitions from the first state to the second state based on an expiration of the inactivity timer.

In some examples, the state transition configuration component 735 is capable of, configured to, or operable to support a means for receiving, from the network entity, an indication of a set of inactivity timer values associated with a transition from the first state to the second state. In some examples, the request includes an indication of a first inactivity timer value of the set of inactivity timer values, the first inactivity timer value selected by the UE based on receiving the indication of the set of inactivity timer values.

In some examples, the state transition response component 765 is capable of, configured to, or operable to support a means for receiving a response message from the network entity based on receiving the indication and transmitting the request. In some examples, the response message indicates that the request is accepted by the network entity, an indication of a second inactivity timer value of the set of inactivity timer values, different than the first inactivity timer value, that the UE is to use for transitioning from the first state to the second state, or any combination thereof. In some examples, transitioning from the first state to the second state is further based on receiving the response message.

In some examples, the state transition request component 725 is capable of, configured to, or operable to support a means for transmitting, to the network entity and while operating in a third state, a second request to transition from the third state to a fourth state based on data activity between the UE and the network entity. In some examples, the state transition response component 740 is capable of, configured to, or operable to support a means for receiving a response message from the network entity based on transmitting the second request. In some examples, the response message indicates that the second request is rejected by the network entity. In some examples, the state transition component 730 is capable of, configured to, or operable to support a means for refraining from transitioning from the third state to the fourth state based on receiving the response message.

In some examples, the state transition request component 725 is capable of, configured to, or operable to support a means for transmitting, via the request, an indication of a requested state for the second state. In some examples, the requested state is associated with a sleep state, an awake state, a state associated with a target bandwidth part, a radio resource control state, a state associated with a deactivation of a secondary cell, or any combination thereof.

In some examples, the state transition configuration component 735 is capable of, configured to, or operable to support a means for receiving a control message from the network entity that configures whether the UE is to transition from the first state to the second state based on an expiration of a timer or to refrain from transitioning from the first state to the second state based on the expiration of the timer. In some examples, the timer is associated with receiving a response message from the network entity. In some examples, the timer component 745 is capable of, configured to, or operable to support a means for starting the timer based on transmitting the request.

In some examples, the state transition component 730 is capable of, configured to, or operable to support a means for transitioning, in accordance with the control message, from the first state to the second state based on failing to receive the response message from the network entity prior to the expiration of the timer.

In some examples, the state transition response component 740 is capable of, configured to, or operable to support a means for receiving the response message from the network entity prior to the expiration of the timer. In some examples, the state transition component 730 is capable of, configured to, or operable to support a means for transitioning, in accordance with the control message, from the first state to the second state based on receiving the response message.

In some examples, the state transition response component 740 is capable of, configured to, or operable to support a means for receiving the response message from the network entity prior to the expiration of the timer. In some examples, the response message includes an indicated state that the UE is to use for the second state. In some examples, the state transition component 730 is capable of, configured to, or operable to support a means for transitioning from the first state to the second state in accordance with the indicated state based on receiving the response message.

In some examples, the state transition request component 725 is capable of, configured to, or operable to support a means for transmitting, to the network entity and while operating in a third state, a second request to transition from the third state to a fourth state based on data activity between the UE and the network entity. In some examples, the state transition response component 740 is capable of, configured to, or operable to support a means for receiving, via the response message, an indication that the network entity rejected the second request from the UE. In some examples, the state transition component 730 is capable of, configured to, or operable to support a means for refraining from transitioning from the third state to the fourth state based on receiving the response message.

In some examples, the machine learning model 750 is capable of, configured to, or operable to support a means for determining a predicted data activity between the UE and the network entity based on a machine learning model at the UE. In some examples, transmitting the request is based on the predicted data activity satisfying a threshold. In some examples, the feedback component 755 is capable of, configured to, or operable to support a means for receiving, based on transmitting the request, a feedback message from the network entity that is associated with the request. In some examples, the model training component 760 is capable of, configured to, or operable to support a means for training the machine learning model based on the feedback message received from the network entity.

In some examples, the state transition configuration component 735 is capable of, configured to, or operable to support a means for receiving a control message that configures a timer associated with transmitting the request. In some examples, the timer component 745 is capable of, configured to, or operable to support a means for starting the timer based on transmitting the request. In some examples, the state transition request component 725 is capable of, configured to, or operable to support a means for refraining from transmitting a second request to transition from a third state to a fourth state prior to an expiration of the timer.

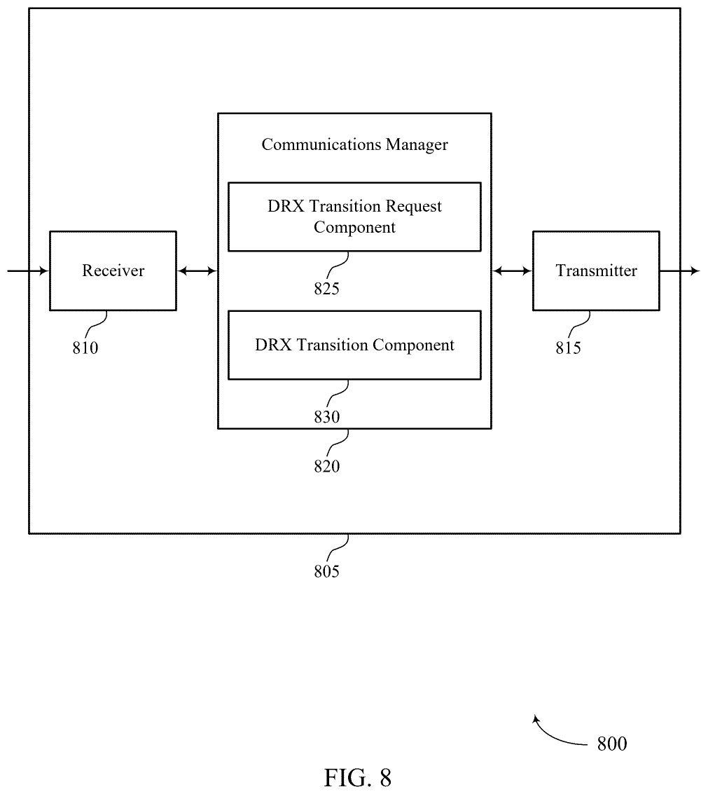

FIG. 8 shows a block diagram 800 of a device 805 that supports dynamic DRX procedures in accordance with one or more aspects of the present disclosure. The device 805 may be an example of aspects of a device 605 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to dynamic DRX procedures). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to dynamic DRX procedures). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of dynamic DRX procedures as described herein. For example, the communications manager 820 may include a DRX transition request component 825 a DRX transition component 830, or any combination thereof. The communications manager 820 may be an example of aspects of a communications manager 620 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The DRX transition request component 825 is capable of, configured to, or operable to support a means for transmitting, within an active period of a DRX cycle, a request to transition to an inactive period of the DRX cycle based on data activity between the UE and a network entity. The DRX transition component 830 is capable of, configured to, or operable to support a means for transitioning to the inactive period of the DRX cycle based on transmitting the request.

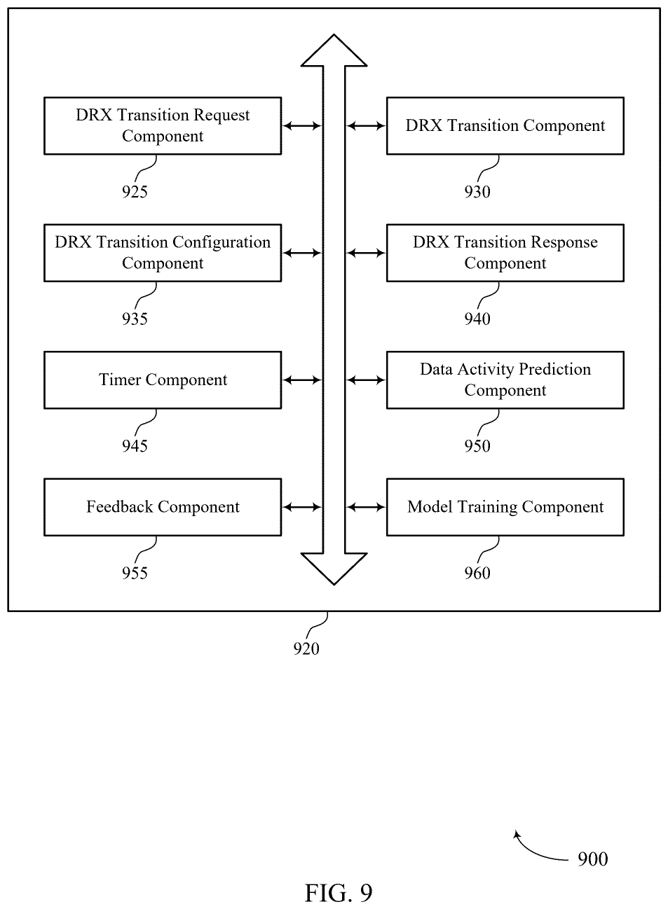

FIG. 9 shows a block diagram 900 of a communications manager 920 that supports dynamic DRX procedures in accordance with one or more aspects of the present disclosure. The communications manager 920 may be an example of aspects of a communications manager 720, as described herein. The communications manager 920, or various components thereof, may be an example of means for performing various aspects of dynamic DRX procedures as described herein. For example, the communications manager 920 may include a DRX transition request component 925, a DRX transition component 930, a DRX transition configuration component 935, a DRX transition response component 940, a timer component 945, a data activity prediction component 950, a feedback component 955, a model training component 960, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The DRX transition request component 925 is capable of, configured to, or operable to support a means for transmitting, within an active period of a DRX cycle, a request to transition to an inactive period of the DRX cycle based on data activity between the UE and a network entity. The DRX transition component 930 is capable of, configured to, or operable to support a means for transitioning to the inactive period of the DRX cycle based on transmitting the request.

In some examples, the DRX transition configuration component 935 is capable of, configured to, or operable to support a means for receiving, from the network entity, an indication of a set of DRX inactivity timer values associated with transitioning to the inactive period of the DRX cycle, where the request includes an indication of a first DRX inactivity timer value of the set of DRX inactivity timer values, the first DRX inactivity timer value selected by the UE based on receiving the indication of the set of DRX inactivity timer values.

In some examples, the DRX transition response component 940 is capable of, configured to, or operable to support a means for receiving a response message from the network entity based on receiving the indication and transmitting the request, where the response message indicates that the request is accepted by the network entity, an indication of a second DRX inactivity timer value of the set of DRX inactivity timer values, different from the first DRX inactivity timer value, that the UE is to use for transitioning to the inactive period of the DRX cycle, or both, where transitioning to the inactive period of the DRX cycle is further based on receiving the response message.

In some examples, the DRX transition request component 925 is capable of, configured to, or operable to support a means for transmitting, within a second active period of a second DRX cycle, a second request to transition to a second inactive period of the second DRX cycle based on data activity between the UE and the network entity. In some examples, the DRX transition response component 940 is capable of, configured to, or operable to support a means for receiving a second response message from the network entity based on transmitting the second request, where the second response message indicates that the second request is rejected by the network entity. In some examples, the DRX transition component 930 is capable of, configured to, or operable to support a means for refraining from transitioning to the second inactive period of the second DRX cycle based on receiving the second response message.

In some examples, the DRX transition request component 925 is capable of, configured to, or operable to support a means for transmitting, via the request, an indication of a duration associated with the inactive period of the DRX cycle.

In some examples, the DRX transition configuration component 935 is capable of, configured to, or operable to support a means for receiving a control message from the network entity that configures whether the UE is to transition to the inactive period of the DRX cycle based on an expiration of a timer or to refrain from transitioning to the inactive period of the DRX cycle based on the expiration of the timer, where the timer is associated with receiving a response message from the network entity. In some examples, the timer component 945 is capable of, configured to, or operable to support a means for starting the timer based on transmitting the request.

In some examples, the DRX transition component 930 is capable of, configured to, or operable to support a means for transitioning, in accordance with the control message, to the inactive period of the DRX cycle based on failing to receive the response message from the network entity prior to the expiration of the timer.

In some examples, the DRX transition response component 940 is capable of, configured to, or operable to support a means for receiving the response message from the network entity prior to the expiration of the timer, where the response message includes an indicated duration that the UE is to use for the inactive period of the DRX cycle. In some examples, the DRX transition component 930 is capable of, configured to, or operable to support a means for transitioning, in accordance with the control message, to the inactive period of the DRX cycle based on receiving the response message.

In some examples, the DRX transition request component 925 is capable of, configured to, or operable to support a means for transmitting, within a second active period of a second DRX cycle, a second request to transition to a second inactive period of the second DRX cycle based on data activity between the UE and the network entity. In some examples, the DRX transition response component 940 is capable of, configured to, or operable to support a means for receiving, via a second response message, an indication that the network entity rejected the second request from the UE. In some examples, the DRX transition component 930 is capable of, configured to, or operable to support a means for refraining from transitioning to the second inactive period of the second DRX cycle based on receiving the second response message.

In some examples, the DRX transition configuration component 935 is capable of, configured to, or operable to support a means for receiving, from the network entity, an indication of a set of DRX cycle configurations, where the request includes a first DRX cycle configuration of the set of DRX cycle configurations, the first DRX cycle configuration selected by the UE based on receiving the indication of the set of DRX cycle configurations.

In some examples, the DRX transition configuration component 935 is capable of, configured to, or operable to support a means for receiving, from the network entity, an indication of a DRX cycle configuration including a set of active periods and a set of inactive periods, where the request includes a parameter that identifies a subset of active periods of the set of active periods within which the UE is active.

In some examples, the DRX transition component 930 is capable of, configured to, or operable to support a means for determining, based on a presence of an active timer value in a configuration of the DRX cycle, to transition to the inactive period of the DRX cycle in accordance with the active timer value.

In some examples, the DRX transition component 930 is capable of, configured to, or operable to support a means for determining, based on an absence of an active timer value in a configuration of the DRX cycle, to refrain from transitioning to a second inactive period of the DRX cycle until transmitting a second request to transition to the second inactive period or until receiving a command from the network entity.

In some examples, the DRX transition response component 940 is capable of, configured to, or operable to support a means for receiving a response message based on transmitting the request prior to transitioning to the inactive period, where the response message indicates whether the UE is to transition to the inactive period of the DRX cycle in accordance with an active timer value, or is to refrain from transitioning to the inactive period of the DRX cycle until transmitting the request.

In some examples, the data activity prediction component 950 is capable of, configured to, or operable to support a means for determining a predicted data activity between the UE and the network entity based on a machine learning model at the UE, where transmitting the request is based on the predicted data activity satisfying a threshold. In some examples, the feedback component 955 is capable of, configured to, or operable to support a means for receiving, based on transmitting the request, a feedback message from the network entity that is associated with the request. In some examples, the model training component 960 is capable of, configured to, or operable to support a means for training the machine learning model based on the feedback message received from the network entity.

In some examples, the DRX transition configuration component 935 is capable of, configured to, or operable to support a means for receiving a control message that configures a timer associated with transmitting the request. In some examples, the timer component 945 is capable of, configured to, or operable to support a means for starting the timer based on transmitting the request. In some examples, the DRX transition request component 925 is capable of, configured to, or operable to support a means for refraining from transmitting a second request to transition to a second inactive period of the DRX cycle prior to an expiration of the timer based on receiving the control message.

In some examples, the DRX transition configuration component 935 is capable of, configured to, or operable to support a means for receiving a control message that configures a default duration for the UE to use for the inactive period of the DRX cycle, where the UE uses the default duration for the inactive period based on an absence of a duration from the request.

In some examples, for the inactive period and for at least a second inactive period of the DRX cycle, the UE uses a first duration that is indicated via the request, or via a response message from the network entity, based on an absence of a second duration from a second request to transition to the second inactive period.

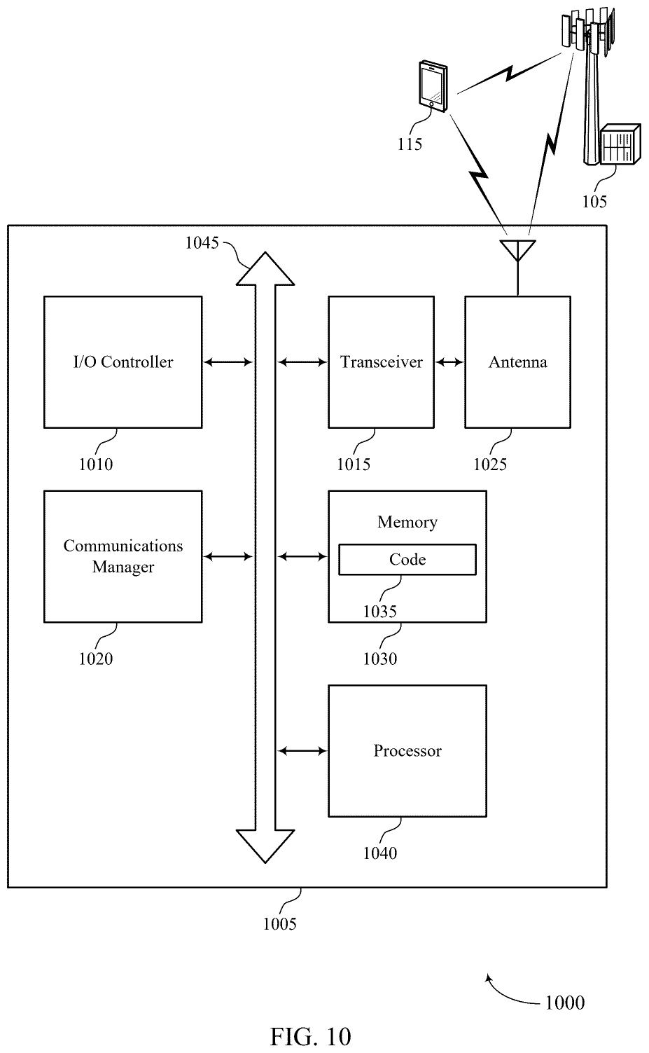

FIG. 10 shows a diagram of a system 1000 including a device 1005 that supports enhanced UE state transitions and dynamic DRX procedures in accordance with one or more aspects of the present disclosure. The device 1005 may be an example of or include components of a device 605, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 615, a receiver 610, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting enhanced UE state transitions or dynamic DRX procedures). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for transmitting, to a network entity and while operating in a first state, a request to transition from the first state to a second state based on data activity between the UE and the network entity. The communications manager 1020 is capable of, configured to, or operable to support a means for transitioning from the first state to the second state based on transmitting the request.

The communications manager 1020 may support wireless communications in accordance with examples as disclosed herein. For example, the communications manager 1020 is capable of, configured to, or operable to support a means for transmitting, within an active period of a DRX cycle, a request to transition to an inactive period of the DRX cycle based on data activity between the UE and a network entity. The communications manager 1020 is capable of, configured to, or operable to support a means for transitioning to the inactive period of the DRX cycle based on transmitting the request.

By including or configuring the communications manager 1020 in accordance with examples as described herein, the device 1005 may support techniques for reduced latency, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of enhanced UE state transitions and dynamic DRX procedures as described herein, or the at least one processor 1040 and the at least one memory 1030 may be otherwise configured to, individually or collectively, perform or support such operations.

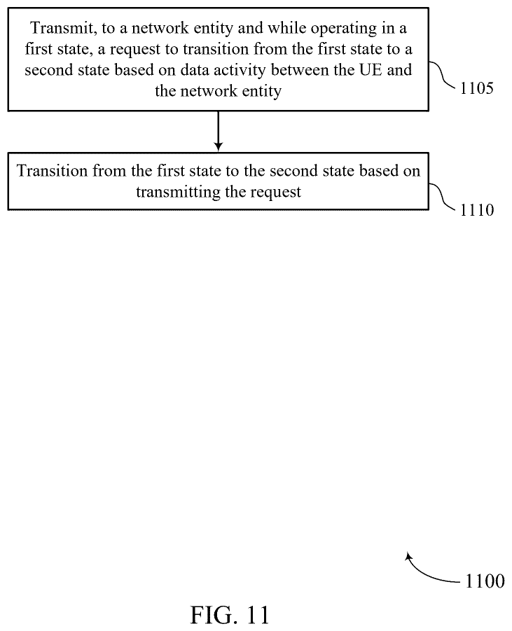

FIG. 11 shows a flowchart illustrating a method 1100 that supports enhanced UE state transitions in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include transmitting, to a network entity and while operating in a first state, a request to transition from the first state to a second state based on data activity between the UE and the network entity. The operations of 1105 may be performed in accordance with examples as disclosed herein. In some examples, aspects of the operations of 1105 may be performed by a state transition request component 725 as described with reference to FIG. 7.

At 1110, the method may include transitioning from the first state to the second state based on transmitting the request. The operations of 1110 may be performed in accordance with examples as disclosed herein. In some examples, aspects of the operations of 1110 may be performed by a state transition component 730 as described with reference to FIG. 7.

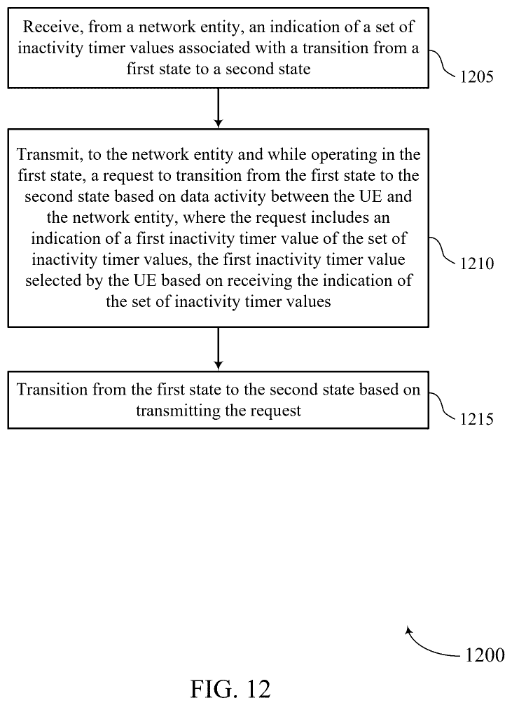

FIG. 12 shows a flowchart illustrating a method 1200 that supports enhanced UE state transitions in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, an indication of a set of inactivity timer values associated with a transition from a first state to a second state. The operations of 1205 may be performed in accordance with examples as disclosed herein. In some examples, aspects of the operations of 1205 may be performed by a state transition configuration component 735 as described with reference to FIG. 7.

At 1210, the method may include transmitting, to the network entity and while operating in a first state, a request to transition from the first state to the second state based on data activity between the UE and the network entity, where the request includes an indication of a first inactivity timer value of the set of inactivity timer values, the first inactivity timer value selected by the UE based on receiving the indication of the set of inactivity timer values. The operations of 1210 may be performed in accordance with examples as disclosed herein. In some examples, aspects of the operations of 1210 may be performed by a state transition request component 725 as described with reference to FIG. 7.

At 1215, the method may include transitioning from the first state to the second state based on transmitting the request. The operations of 1215 may be performed in accordance with examples as disclosed herein. In some examples, aspects of the operations of 1215 may be performed by a state transition component 730 as described with reference to FIG. 7.

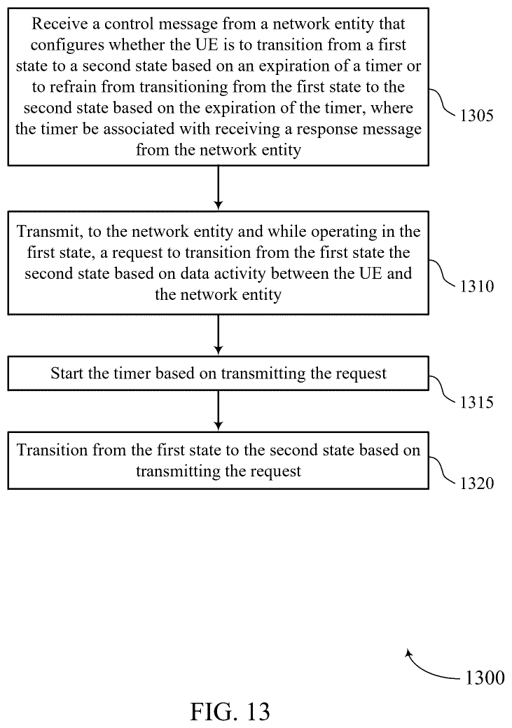

FIG. 13 shows a flowchart illustrating a method 1300 that supports enhanced UE state transitions in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving a control message from a network entity that configures whether the UE is to transition from a first state to a second state based on an expiration of a timer or to refrain from transitioning from the first state to the second state based on the expiration of the timer, where the timer is associated with receiving a response message from the network entity. The operations of 1305 may be performed in accordance with examples as disclosed herein. In some examples, aspects of the operations of 1305 may be performed by a state transition configuration component 735 as described with reference to FIG. 7.

At 1310, the method may include transmitting, to the network entity and while operating in the first state, a request to transition from the first state to the second state based on data activity between the UE and the network entity. The operations of 1310 may be performed in accordance with examples as disclosed herein. In some examples, aspects of the operations of 1310 may be performed by a state transition request component 725 as described with reference to FIG. 7.

At 1315, the method may include starting the timer based on transmitting the request. The operations of 1315 may be performed in accordance with examples as disclosed herein. In some examples, aspects of the operations of 1315 may be performed by a timer component 745 as described with reference to FIG. 7.

At 1320, the method may include transitioning from the first state to the second state based on transmitting the request. The operations of 1320 may be performed in accordance with examples as disclosed herein. In some examples, aspects of the operations of 1320 may be performed by a state transition component 730 as described with reference to FIG. 7.

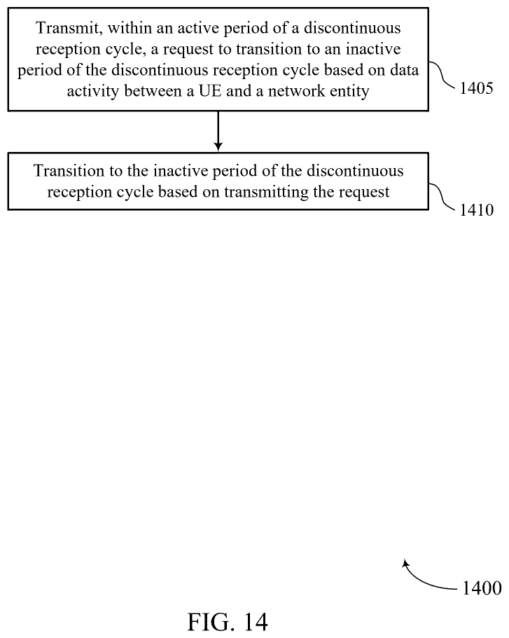

FIG. 14 shows a flowchart illustrating a method 1400 that supports dynamic DRX procedures in accordance with one or more aspects of the present disclosure. The operations of the method 1400 may be implemented by a UE or its components as described herein. For example, the operations of the method 1400 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1405, the method may include transmitting, within an active period of a DRX cycle, a request to transition to an inactive period of the DRX cycle based on data activity between a UE and a network entity. The operations of 1405 may be performed in accordance with examples as disclosed herein. In some examples, aspects of the operations of 1405 may be performed by a DRX transition request component 925 as described with reference to FIG. 9.

At 1410, the method may include transitioning to the inactive period of the DRX cycle based on transmitting the request. The operations of 1410 may be performed in accordance with examples as disclosed herein. In some examples, aspects of the operations of 1410 may be performed by a DRX transition component 930 as described with reference to FIG. 9.

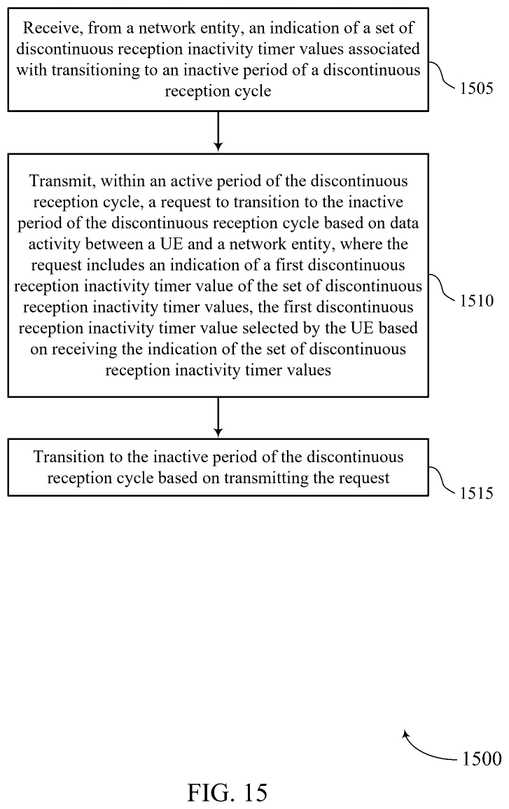

FIG. 15 shows a flowchart illustrating a method 1500 that supports dynamic DRX procedures in accordance with one or more aspects of the present disclosure. The operations of the method 1500 may be implemented by a UE or its components as described herein. For example, the operations of the method 1500 may be performed by a UE 115 as described with reference to FIGS. 1 through 14. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, an indication of a set of DRX inactivity timer values associated with transitioning to an inactive period of a DRX cycle. The operations of 1505 may be performed in accordance with examples as disclosed herein. In some examples, aspects of the operations of 1505 may be performed by a DRX transition configuration component 935 as described with reference to FIG. 9.

At 1510, the method may include transmitting, within an active period of the DRX cycle, a request to transition to the inactive period of the DRX cycle based on data activity between a UE and a network entity, where the request includes an indication of a first DRX inactivity timer value of the set of DRX inactivity timer values, the first DRX inactivity timer value selected by the UE based on receiving the indication of the set of DRX inactivity timer values. The operations of 1510 may be performed in accordance with examples as disclosed herein. In some examples, aspects of the operations of 1510 may be performed by a DRX transition request component 925 as described with reference to FIG. 9.

At 1515, the method may include transitioning to the inactive period of the DRX cycle based on transmitting the request. The operations of 1515 may be performed in accordance with examples as disclosed herein. In some examples, aspects of the operations of 1515 may be performed by a DRX transition component 930 as described with reference to FIG. 9.

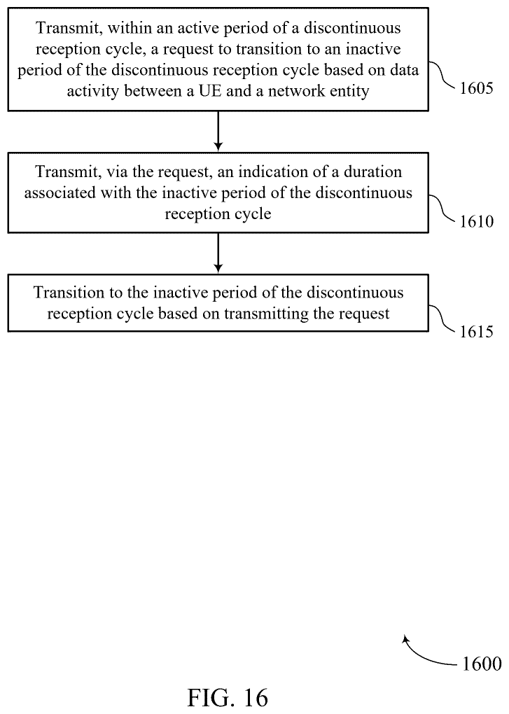

FIG. 16 shows a flowchart illustrating a method 1600 that supports dynamic DRX procedures in accordance with one or more aspects of the present disclosure. The operations of the method 1600 may be implemented by a UE or its components as described herein. For example, the operations of the method 1600 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 1605, the method may include transmitting, within an active period of a DRX cycle, a request to transition to an inactive period of the DRX cycle based on data activity between a UE and a network entity. The operations of 1605 may be performed in accordance with examples as disclosed herein. In some examples, aspects of the operations of 1605 may be performed by a DRX transition request component 925 as described with reference to FIG. 9.

At 1610, the method may include transmitting, via the request, an indication of a duration associated with the inactive period of the DRX cycle. The operations of 1610 may be performed in accordance with examples as disclosed herein. In some examples, aspects of the operations of 1610 may be performed by a DRX transition request component 925 as described with reference to FIG. 9.

At 1615, the method may include transitioning to the inactive period of the DRX cycle based on transmitting the request. The operations of 1615 may be performed in accordance with examples as disclosed herein. In some examples, aspects of the operations of 1615 may be performed by a DRX transition component 930 as described with reference to FIG. 9.

The following provides an overview of aspects of the present disclosure:

Aspect 1: A method for wireless communications by a UE, comprising: transmitting, to a network entity and while operating in a first state, a request to transition from the first state to a second state based at least in part on data activity between the UE and the network entity, where the transition from the first state to the second state is associated with an inactivity timer at the UE; and transitioning, based at least in part on transmitting the request, from the first state to the second state in accordance with a state of the inactivity timer.

Aspect 2: The method of aspect 1, wherein the request to transition from the first state to the second state comprises a requested value for the inactivity timer at the UE; and the UE transitions from the first state to the second state based at least in part on an expiration of the inactivity timer.

Aspect 3: The method of any of aspects 1 through 2, further comprising: receiving, from the network entity, an indication of a set of inactivity timer values for the inactivity timer, wherein the request comprises an indication of a first inactivity timer value of the set of inactivity timer values, the first inactivity timer value selected by the UE based at least in part on receiving the indication of the set of inactivity timer values.

Aspect 4: The method of aspect 3, further comprising: receiving a response message from the network entity based at least in part on receiving the indication and transmitting the request, wherein the response message indicates that the request is accepted by the network entity, an indication of a second inactivity timer value of the set of inactivity timer values, different than the first inactivity timer value, that the UE is to use for transitioning from the first state to the second state, or any combination thereof, and wherein transitioning from the first state to the second state is further based at least in part on receiving the response message.

Aspect 5: The method of any of aspects 1 through 2, further comprising: transmitting, to the network entity and while operating in a third state, a second request to transition from the third state to a fourth state based at least in part on data activity between the UE and the network entity; receiving a response message from the network entity based at least in part on transmitting the second request, wherein the response message indicates that the second request is rejected by the network entity; and refraining from transitioning from the third state to the fourth state based at least in part on receiving the response message.

Aspect 6: The method of any of aspects 1 through 5, further comprising: transmitting, via the request, an indication of a requested state for the second state, wherein the requested state is associated with a sleep state, an awake state, a state associated with a target BWP, an RRC state, a state associated with a deactivation of a secondary cell, or any combination thereof.

Aspect 7: The method of any of aspects 1 through 6, further comprising: receiving a control message from the network entity that configures whether the UE is to transition from the first state to the second state based at least in part on an expiration of a timer or to refrain from transitioning from the first state to the second state based at least in part on the expiration of the timer, wherein the timer is associated with receiving a response message from the network entity; and starting the timer is based at least in part on transmitting the request.

Aspect 8: The method of aspect 7, further comprising: transitioning, in accordance with the control message, from the first state to the second state based at least in part on failing to receive the response message from the network entity prior to the expiration of the timer.

Aspect 9: The method of aspect 7, further comprising: receiving the response message from the network entity prior to the expiration of the timer; and transitioning, in accordance with the control message, from the first state to the second state based at least in part on receiving the response message.

Aspect 10: The method of any of aspects 7 and 9, further comprising: receiving the response message from the network entity prior to the expiration of the timer, wherein the response message comprises an indicated state that the UE is to use for the second state; and transitioning from the first state to the second state in accordance with the indicated state based at least in part on receiving the response message.

Aspect 11: The method of any of aspects 7 and 9, further comprising: transmitting, to the network entity and while operating in a third state, a second request to transition from the third state to a fourth state based at least in part on data activity between the UE and the network entity; receiving, via the response message, an indication that the network entity rejected the second request from the UE; and refraining from transitioning from the third state to the fourth state based at least in part on receiving the response message.

Aspect 12: The method of any of aspects 1 through 11, further comprising: determining a predicted data activity between the UE and the network entity based at least in part on a machine learning model at the UE, wherein transmitting the request is based at least in part on the predicted data activity satisfying a threshold; receiving, based at least in part on transmitting the request, a feedback message from the network entity that is associated with the request; and training the machine learning model based at least in part on the feedback message received from the network entity.

Aspect 13: The method of any of aspects 1 through 12, further comprising: receiving a control message that configures a timer associated with transmitting the request; starting the timer based at least in part on transmitting the request; and refraining from transmitting a second request to transition from a third state to a fourth state prior to an expiration of the timer.

Aspect 14: A UE for wireless communications, comprising one or more memories storing processor-executable code, and one or more processors coupled with the one or more memories and individually or collectively operable to execute the code to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

Aspect 17: A method for wireless communications by a UE, comprising: transmitting, within an active period of a DRX cycle, a request to transition to an inactive period of the DRX cycle based at least in part on data activity between the UE and a network entity; and transitioning to the inactive period of the DRX cycle based at least in part on transmitting the request.

Aspect 18: The method of aspect 17, further comprising: receiving, from the network entity, an indication of a set of DRX inactivity timer values associated with transitioning to the inactive period of the DRX cycle, wherein the request comprises an indication of a first DRX inactivity timer value of the set of DRX inactivity timer values, the first DRX inactivity timer value selected by the UE based at least in part on receiving the indication of the set of DRX inactivity timer values.

Aspect 19: The method of aspect 18, further comprising: receiving a response message from the network entity based at least in part on receiving the indication and transmitting the request, wherein the response message indicates that the request is accepted by the network entity, an indication of a second DRX inactivity timer value of the set of DRX inactivity timer values, different from the first DRX inactivity timer value, that the UE is to use for transitioning to the inactive period of the DRX cycle, or both, and wherein transitioning to the inactive period of the DRX cycle is further based at least in part on receiving the response message.

Aspect 20: The method of aspect 17, further comprising: transmitting, within a second active period of a second DRX cycle, a second request to transition to a second inactive period of the second DRX cycle based at least in part on data activity between the UE and the network entity; receiving a second response message from the network entity based at least in part on transmitting the second request, wherein the second response message indicates that the second request is rejected by the network entity; and refraining from transitioning to the second inactive period of the second DRX cycle based at least in part on receiving the second response message.

Aspect 21: The method of any of aspects 17 through 20, further comprising: transmitting, via the request, an indication of a duration associated with the inactive period of the DRX cycle.

Aspect 22: The method of any of aspects 17 through 21, further comprising: receiving a control message from the network entity that configures whether the UE is to transition to the inactive period of the DRX cycle based at least in part on an expiration of a timer or to refrain from transitioning to the inactive period of the DRX cycle based at least in part on the expiration of the timer, wherein the timer is associated with receiving a response message from the network entity; and starting the timer based at least in part on transmitting the request.

Aspect 23: The method of aspect 22, further comprising: transitioning, in accordance with the control message, to the inactive period of the DRX cycle based at least in part on failing to receive the response message from the network entity prior to the expiration of the timer.

Aspect 24: The method of aspect 22, further comprising: receiving the response message from the network entity prior to the expiration of the timer; wherein the response message comprises an indicated duration that the UE is to use for the inactive period of the DRX cycle; and transitioning, in accordance with the control message, to the inactive period of the DRX cycle based at least in part on receiving the response message.

Aspect 25: The method of aspect 22, further comprising: transmitting, within a second active period of a second DRX cycle, a second request to transition to a second inactive period of the second DRX cycle based at least in part on data activity between the UE and the network entity; receiving, via a second response message, an indication that the network entity rejected the second request from the UE; and refraining from transitioning to the second inactive period of the second DRX cycle based at least in part on receiving the second response message.

Aspect 26: The method of any of aspects 17 through 25, further comprising: receiving, from the network entity, an indication of a set of DRX cycle configurations, wherein the request comprises a first DRX cycle configuration of the set of DRX cycle configurations, the first DRX cycle configuration selected by the UE based at least in part on receiving the indication of the set of DRX cycle configurations.

Aspect 27: The method of any of aspects 17 through 26, further comprising: receiving, from the network entity, an indication of a DRX cycle configuration comprising a set of active periods and a set of inactive periods, wherein the request comprises a parameter that identifies a subset of active periods of the set of active periods within which the UE is active.

Aspect 28: The method of any of aspects 17 through 27, further comprising: determining, based at least in part on a presence of an active timer value in a configuration of the DRX cycle, to transition to the inactive period of the DRX cycle in accordance with the active timer value.

Aspect 29: The method of any of aspects 17 through 27, further comprising: determining, based at least in part on an absence of an active timer value in a configuration of the DRX cycle, to refrain from transitioning to a second inactive period of the DRX cycle until transmitting a second request to transition to the second inactive period or until receiving a command from the network entity.

Aspect 30: The method of any of aspects 17 through 29, further comprising: receiving a response message based at least in part on transmitting the request prior to transitioning to the inactive period, wherein the response message indicates whether the UE is to transition to the inactive period of the DRX cycle in accordance with an active timer value, or is to refrain from transitioning to the inactive period of the DRX cycle until transmitting the request.

Aspect 31: The method of any of aspects 17 through 30, further comprising: determining a predicted data activity between the UE and the network entity based at least in part on a machine learning model at the UE, wherein transmitting the request is based at least in part on the predicted data activity satisfying a threshold; receiving, based at least in part on transmitting the request, a feedback message from the network entity that is associated with the request; and training the machine learning model based at least in part on the feedback message received from the network entity.

Aspect 32: The method of any of aspects 17 through 31, further comprising: receiving a control message that configures a timer associated with transmitting the request; starting the timer based at least in part on transmitting the request; and refraining from transmitting a second request to transition to a second inactive period of the DRX cycle prior to an expiration of the timer based at least in part on receiving the control message.

Aspect 33: The method of any of aspects 17 through 32, further comprising: receiving a control message that configures a default duration for the UE to use for the inactive period of the DRX cycle, wherein the UE uses the default duration for the inactive period based at least in part on an absence of a duration from the request.

Aspect 34: The method of any of aspects 17 through 33, wherein for the inactive period and for at least a second inactive period of the DRX cycle, the UE uses a first duration that is indicated via the request, or via a response message from the network entity, based at least in part on an absence of a second duration from a second request to transition to the second inactive period.

Aspect 35: A UE for wireless communications, comprising one or more memories storing processor-executable code, and one or more processors coupled with the one or more memories and individually or collectively operable to execute the code to cause the UE to perform a method of any of aspects 17 through 34.

Aspect 36: A UE for wireless communications, comprising at least one means for performing a method of any of aspects 17 through 34.

Aspect 37: A non-transitory computer-readable medium storing code for wireless communications, the code comprising instructions executable by one or more processors to perform a method of any of aspects 17 through 34.

Additional example embodiments of the techniques discussed herein are described in the attached appendix.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a network entity and while operating in a first state, a request to transition from the first state to a second state based at least in part on data activity between the UE and the network entity, wherein the transition from the first state to the second state is associated with an inactivity timer at the UE; and
transition, based at least in part on transmitting the request, from the first state to the second state in accordance with a state of the inactivity timer.

2. The UE of claim 1, wherein:
the request to transition from the first state to the second state comprises a requested value for the inactivity timer at the UE; and
the UE transitions from the first state to the second state based at least in part on an expiration of the inactivity timer.

3. The UE of claim 1, wherein the one or more processors are individually or collectively further operable to execute the code to cause the UE to:
receive, from the network entity, an indication of a set of inactivity timer values for the inactivity timer,
wherein the request comprises an indication of a first inactivity timer value of the set of inactivity timer values, the first inactivity timer value selected by the UE based at least in part on receiving the indication of the set of inactivity timer values.

4. The UE of claim 3, wherein the one or more processors are individually or collectively further operable to execute the code to cause the UE to:
receive a response message from the network entity based at least in part on receiving the indication and transmitting the request, wherein the response message indicates that the request is accepted by the network entity, an indication of a second inactivity timer value of the set of inactivity timer values, different than the first inactivity timer value, that the UE is to use for transitioning from the first state to the second state, or any combination thereof, and wherein transition from the first state to the second state is further based at least in part on receiving the response message.

5. The UE of claim 1, wherein the one or more processors are individually or collectively further operable to execute the code to cause the UE to:
transmit, to the network entity and while operating in a third state, a second request to transition from the third state to a fourth state based at least in part on data activity between the UE and the network entity;
receive a response message from the network entity based at least in part on transmitting the second request,
wherein the response message indicates that the second request is rejected by the network entity; and
refrain from transitioning from the third state to the fourth state based at least in part on receiving the response message.

6. The UE of claim 1, wherein the one or more processors are individually or collectively further operable to execute the code to cause the UE to:
transmit, via the request, an indication of a requested state for the second state,
wherein the requested state is associated with a sleep state, an awake state, a state associated with a target bandwidth part, a radio resource control state, a state associated with a deactivation of a secondary cell, or any combination thereof.

7. The UE of claim 1, wherein the one or more processors are individually or collectively further operable to execute the code to cause the UE to:
receive a control message from the network entity that configures whether the UE is to transition from the first state to the second state based at least in part on an expiration of a timer or to refrain from transitioning from the first state to the second state based at least in part on the expiration of the timer,
wherein the timer is associated with receiving a response message from the network entity; and
start the timer based at least in part on transmitting the request.

8. The UE of claim 1, wherein the one or more processors are individually or collectively further operable to execute the code to cause the UE to:
determine a predicted data activity between the UE and the network entity based at least in part on a machine learning model at the UE,
wherein transmit the request is based at least in part on the predicted data activity satisfying a threshold;
receive, based at least in part on transmitting the request, a feedback message from the network entity that is associated with the request; and
train the machine learning model based at least in part on the feedback message received from the network entity.

9. The UE of claim 1, wherein the one or more processors are individually or collectively further operable to execute the code to cause the UE to:
receive a control message that configures a timer associated with transmitting the request;
start the timer based at least in part on transmitting the request; and
refrain from transmitting a second request to transition from a third state to a fourth state prior to an expiration of the timer.

10. The UE of claim 1, wherein operating in the first state comprises operating during an active period of a discontinuous reception cycle, and wherein transitioning from the first state to the second state comprises transitioning to an inactive period of the discontinuous reception cycle.

11. A user equipment (UE), comprising:
one or more memories storing processor-executable code; and
one or more processors coupled with the one or more memories and individually or collectively operable to execute the code to cause the UE to:
transmit, within an active period of a discontinuous reception cycle, a request to transition to an inactive period of the discontinuous reception cycle based at least in part on data activity between the UE and a network entity; and
transition to the inactive period of the discontinuous reception cycle based at least in part on transmitting the request.

12. The UE of claim 11, wherein the one or more processors are individually or collectively further operable to execute the code to cause the UE to:
transmit, via the request, an indication of a duration associated with the inactive period of the discontinuous reception cycle.

13. The UE of claim 11, wherein the one or more processors are individually or collectively further operable to execute the code to cause the UE to:
receive a control message from the network entity that configures whether the UE is to transition to the inactive period of the discontinuous reception cycle based at least in part on an expiration of a timer or to refrain from transitioning to the inactive period of the discontinuous reception cycle based at least in part on the expiration of the timer,
wherein the timer is associated with receiving a response message from the network entity; and
start the timer based at least in part on transmitting the request.

14. The UE of claim 13, wherein the one or more processors are individually or collectively further operable to execute the code to cause the UE to:
transition, in accordance with the control message, to the inactive period of the discontinuous reception cycle based at least in part on failing to receive the response message from the network entity prior to the expiration of the timer.

15. The UE of claim 13, wherein the one or more processors are individually or collectively further operable to execute the code to cause the UE to:
receive the response message from the network entity prior to the expiration of the timer;
wherein the response message comprise an indicated duration that the UE is to use for the inactive period of the discontinuous reception cycle; and
transition, in accordance with the control message, to the inactive period of the discontinuous reception cycle based at least in part on receiving the response message.

16. The UE of claim 13, wherein the one or more processors are individually or collectively further operable to execute the code to cause the UE to:
transmit, within a second active period of a second discontinuous reception cycle, a second request to transition to a second inactive period of the second discontinuous reception cycle based at least in part on data activity between the UE and the network entity;
receive, via a second response message, an indication that the network entity rejected the second request from the UE; and
refrain from transitioning to the second inactive period of the second discontinuous reception cycle based at least in part on receiving the second response message.

17. The UE of claim 11, wherein the one or more processors are individually or collectively further operable to execute the code to cause the UE to:
determine, based at least in part on an absence of an active timer value in a configuration of the discontinuous reception cycle, to refrain from transitioning to a second inactive period of the discontinuous reception cycle until transmitting a second request to transition to the second inactive period or until receiving a command from the network entity.

18. The UE of claim 11, wherein the one or more processors are individually or collectively further operable to execute the code to cause the UE to:
receive a response message based at least in part on transmitting the request prior to transitioning to the inactive period,
wherein the response message indicate whether the UE is to transition to the inactive period of the discontinuous reception cycle in accordance with an active timer value, or is to refrain from transitioning to the inactive period of the discontinuous reception cycle until transmitting the request.

19. The UE of claim 11, wherein the one or more processors are individually or collectively further operable to execute the code to cause the UE to:
receive a control message that configures a default duration for the UE to use for the inactive period of the discontinuous reception cycle,
wherein the UE used the default duration for the inactive period based at least in part on an absence of a duration from the request.

20. A method for wireless communications by a user equipment (UE), comprising:
transmitting, to a network entity and while operating in a first state, a request to transition from the first state to a second state based at least in part on data activity between the UE and the network entity, wherein the transition from the first state to the second state is associated with an inactivity timer at the UE; and
transitioning, based at least in part on transmitting the request, from the first state to the second state in accordance with a state of the inactivity timer.
